(19) United States
(12) Patent Application Publication
(10) Pub. No.: US 2015/0252250 A1
(43) Pub. Date: Sep. 10, 2015

(54) SYNTHETIC HYDRATABLE POLYMERS FOR USE IN FRACTURING FLUIDS AND METHODS FOR MAKING AND USING SAME

(71) Applicant: Clearwater International LLC, Houston, TX (US)

(72) Inventors: Simon Levey, Houston, TX (US); Clayton S. Smith, Houston, TX (US); Rajesh Saini, Houston, TX (US); Susanna Wong, Houston, TX (US)

(21) Appl. No.: 14/628,223

(22) Filed: Feb. 21, 2015

Related U.S. Application Data
(60) Provisional application No. 61/942,781, filed on Feb. 21, 2014.

(51) Int. Cl. C09K 8/68; E21B 43/267; C09K 8/80; E21B 43/26

(52) U.S. Cl. CPC C09K 8/685; E21B 43/26; E21B 43/267; C09K 8/80

(57) ABSTRACT

Downhole fluid compositions including a base fluid and an effective amount of a synthetic hydratable polymer system including a hydrophobically modified, cross-linked polyacrylate polymer, a hydrophilic, anionic, high molecular weight, cross-linked polyacrylic acid polymer, or mixtures and combinations thereof, where the effective amount is sufficient to achieve a desired viscosity profile and a desired breaking profile in the present of a breaking system in the absence of natural hydratable polymers.

### RELATED APPLICATIONS

The present invention claim provisional priority to and the benefit of U.S. Provisional Patent Application Ser. No. 61/942,781 filed 21 Feb. 2014 (Feb. 21, 2014)(21 Feb. 2014).

### BACKGROUND OF THE INVENTION

1. Field of the Invention

Embodiments of the present invention relate to synthetic hydratable polymers and synthetic hydratable polymer blends as guar alternative for used in downhole fluids, and to methods for making and using same.

More particularly, embodiments of the present invention relate to synthetic hydratable polymers and synthetic hydratable polymer blends as guar alternative for used in downhole fluids, where the synthetic hydratable polymers include hydrophobically modified, cross-linked polyacrylate polymers and/or hydrophilic, anionic, high molecular weight, cross-linked polyacrylic acid polymer, and to methods for making and using same.

2. Description of the Related Art

Water based fracturing fluids are currently utilized on the majority of hydraulic fracturing treatments. These fluids are the systems of choice due to their economics, availability, toxicity and safe handling compared with hydrocarbon systems.

Guar is a natural polymer, and is commonly utilized as a water based gelling agent in fracturing fluids. Guar is a hydrocolloid that swells upon contact with water to provide viscosity and fluid loss control. Due to strong export demands for guar gum and low carryover stocks, the price of guar has risen sharply recently and has made synthetic alternatives more attractive.

Thus, there is a need in the art for the development of synthetic alternatives to naturally guar for use in downhole fluids.

### SUMMARY OF THE INVENTION

### Synthetic Polymer Compositions

Embodiments of the present invention provide synthetic polymer compositions including a major amount of synthetic hydratable polymers and a minor amount of natural hydratable polymers for use in fracturing fluids or other high viscosity fluids that build viscosity after being combined with an aqueous base fluid and are capable of being broken using conventional breakers, where the major amount is between 80 wt. % up to 100 wt. % and the minor amount is between 0 wt. % and 20 wt. %. In certain embodiments, the synthetic polymer compositions include 100 wt. % of synthetic hydratable polymers. The synthetic hydratable polymers are selected from the group consisting of (a) high molecular weight homo- and/or copolymers of acrylic acid crosslinked with polyalkenyl polyethers, (b) high molecular weight hydrophobically modified, cross-linked polyacrylate polymers, (c) hydrophilic, anionic, high molecular weight, cross-linked polyacrylic acid polymers, and (d) mixtures or combinations thereof.

### Fracturing Fluids

Embodiments of the present invention provide fracturing fluids including a base fluid and a synthetic polymer composition including a major amount of synthetic hydratable polymers and a minor amount of natural hydratable polymers, where the synthetic polymer compositions are capable of increasing the viscosity of the base fluids after addition and of being broken using one breaker or a plurality of breakers, where the major amount is between 80 wt. % up to 100 wt. % and the minor amount is between 0 wt. % and 20 wt. %. In certain embodiments, the synthetic polymer compositions include 100 wt. % of synthetic hydratable polymers. The synthetic hydratable polymers selected from the group consisting of (a) high molecular weight homo- and/or copolymers of acrylic acid crosslinked with polyalkenyl polyethers, (b) high molecular weight hydrophobically modified, cross-linked polyacrylate polymers, (c) hydrophilic, anionic, high molecular weight, cross-linked polyacrylic acid polymers, and (d) mixtures or combinations thereof. In certain embodiment, the fracturing fluids further include proppants. In other embodiments, the fracturing fluids further include other additives to modify the behavior of the fracturing fluids. In other embodiments, the fracturing fluids further include a breaker composition capable of breaking the fracturing fluid in a controlled manner. In other embodiments, the fracturing fluids further include a crosslinking system to build viscosity. In other embodiments, the breaker composition comprising brines as the synthetic polymer compositions have been shown to loose viscosity as the salinity of the base fluid is increased. Thus, in certain embodiments, encapsulated salts may be used as breakers, where the encapsulating material release the encapsulated salt after a desired time of exposure to the base fluid or in response to addition of an agent that disrupts the encapsulating material and releases the salt.

### Methods for Making the Fracturing Fluids

Embodiments of the present invention provide methods for making fracturing fluids including combining a base fluid and an effective amount of a synthetic polymer composition under condition sufficient to form a fracturing fluid having a desired viscosity profile and a desired breaker profile. The synthetic polymer compositions include a major amount of synthetic hydratable polymers and a minor amount of natural hydratable polymers, where the synthetic polymer compositions are capable of increasing the viscosity of the base fluids after addition and of being broken using one breaker or a plurality of breakers, where the major amount is between 80 wt. % up to 100 wt. % and the minor amount is between 0 wt. % and 20 wt. %. In certain embodiments, the synthetic polymer compositions include 100 wt. % of synthetic hydratable polymers. The synthetic polymer compositions are capable of increasing a viscosity of the base fluid to the desired viscosity profile and being broken using one breaker or a plurality of breakers producing the desired breaking profile. In certain embodiments, the methods include adding a synthetic hydratable polymer composition to the base fluid before or during injection of the base fluid downhole. In certain embodiments, the synthetic hydratable polymers selected from the group consisting of (a) high molecular weight homo- and/or copolymers of acrylic acid crosslinked with polyalkenyl polyethers, (b) high molecular weight hydrophobically modified, cross-linked polyacrylate polymers, (c) hydrophilic, anionic, high molecular weight, cross-linked polyacrylic acid polymers, and (d) mixtures or combinations thereof. In certain embodiment, the fracturing fluids further include proppants. In other embodiments, the fracturing fluids further include other additives to modify the behavior of the fracturing fluids. In other embodiments, the fracturing fluids further include a breaker composition capable of breaking the fracturing fluid in a controlled manner. In other embodiments, the fracturing fluids further include a crosslinking system to build viscosity.

### Methods for Fracturing Formations

Embodiments of the present invention provide methods for fracturing a formation or formation zone using fracturing fluids including a base fluid and an effective amount of a synthetic polymer composition under condition sufficient to form a fracturing fluid having a desired viscosity profile and a desired breaker profile. The synthetic polymer compositions include a major amount of synthetic hydratable polymers and a minor amount of natural hydratable polymers. The synthetic polymer compositions are used in hydratable fracturing fluids or other high viscosity fluid that build viscosity after being combined with an aqueous base fluid and are capable of being broken using conventional breakers. The methods include injecting a fracturing fluid into a formation under fracturing conditions, where the synthetic hydratable polymer composition is added to the base fluid before or during injection of the base fluid downhole. The major amount is between 80 wt. % up to 100 wt. % and the minor amount is between 0 wt. % and 20 wt. %. In certain embodiments, the synthetic polymer compositions include 100 wt. % of synthetic hydratable polymers. In certain embodiments, the synthetic hydratable polymers selected from the group consisting of (a) high molecular weight homo- and/or copolymers of acrylic acid crosslinked with polyalkenyl polyethers, (b) high molecular weight hydrophobically modified, cross-linked polyacrylate polymers, (c) hydrophilic, anionic, high molecular weight, cross-linked polyacrylic acid polymers, and (d) mixtures or combinations thereof. In certain embodiment, the fracturing fluids further include proppants. In other embodiments, the fracturing fluids further include other additives to modify the behavior of the fracturing fluids. In other embodiments, the fracturing fluids further include a breaker composition capable of breaking the fracturing fluid in a controlled manner. In other embodiments, the fracturing fluids further include a crosslinking system to build viscosity.

### BRIEF DESCRIPTION OF THE DRAWINGS

The invention can be better understood with reference to the following detailed description together with the appended illustrative drawings in which like elements are numbered the same:

FIGS. 1A&B depict a typical PVS Rheometer.

FIG. 2 depicts hydration rate profiles of P1 systems at room temperature.

FIG. 3 depicts a hydration rate profile of a P1 system in 2 wt. % KCl at room temperature.

FIG. 4 depicts a hydration rate profiles of P2 systems with different base concentrations in 2 wt. % KCl at room temperature.

FIG. 5 depicts hydration rate profile of a P2 system in seawater at room temperature.

FIG. 6 depicts hydration rate profile of a 1.0 wt. % P3 system in 2 wt. % KCl at room temperature.

FIG. 7 depicts hydration rate profile of 1.3 wt. % P3 system in 2 wt. % KCl at room temperature.

FIG. 8 depicts hydration rate profile of 1.5 wt. % P3 system in 2 wt. % KCl at room temperature.

FIG. 9 depicts the effect of pH on P1-5 systems in 2 wt. % KCl at room temperature.

FIG. 10 depicts the effect of pH on P1-5 systems in seawater at room temperature.

FIG. 11 depicts the effect of pH on P2 systems in 2 wt. % KCl at room temperature.

FIG. 12 depicts the effect of pH on P2 systems in Sea Water at room temperature.

FIG. 13 depicts viscosity stability profiles for a P1 system at 60° C., 80° C., and 100° C.

FIG. 14 depicts gel stability testing for P1-P5 systems at 80° C.

FIG. 15 depicts the effect of temperature on a P2 system.

FIG. 16 depicts the effect of temperature on a P5 system.

FIG. 17 depicts the effect of temperature on a P3 system.

FIG. 18 depicts the effect of temperature on a P2 system.

FIG. 19 depicts the effect of breaker B1 concentrations on a 0.4 wt. % P1 system at 80° C.

FIG. 20 depicts the effect of breaker B1 concentrations on a 0.4 wt. % P1 system at 100° C.

FIG. 21 depicts the effect of breaker B2 concentrations on a 0.4 wt. % P1 system at 100° C.

FIG. 22 depicts the effect of breaker B3 on a 0.4 wt. % P1 system at 80° C.

FIG. 23 depicts the effect of breaker B7 on a 1.2 wt. % P2 system at 65° C.

FIG. 24 depicts the effect of breaker B3 on a 1.2 wt. % P2 system at 80° C.

FIG. 25 depicts the effect of different breakers on a 1.2 wt. % P2 system at 100° C.

FIG. 26 depicts the effect of breaker B8 on 1.2 wt. % P2 system in 2 wt. % KCl at 100° C.

FIG. 27 depicts the effect of breaker B8 on 1.2 wt. % P2 system in 2 wt. % KCl at 120° C.

FIG. 28 depicts the effect of breaker B5 on 1.2 wt. % P2 system in 2 wt. % KCl at 120° C.

FIG. 29 depicts the effect of breaker B8 on 1.2 wt. % P2 system in 2 wt. % KCl at 149° C.

FIG. 30 depicts the effect of 2 gpt WNE-363 on 1.2 wt. % P2 system in 2 wt. % KCl at 100° C.

FIG. 31 depicts the effect of 0.05 gpt BioClear 2000 on 1.2 wt. % P2 system in 2 wt. % KCl at 100° C.

FIG. 32 depicts the effect of 3 gpt WGS-160L on 1.2 wt. % P2 system in 2 wt. % KCl at 100° C.

FIG. 33 depicts the effect of 2 gpt WCS-631LC on 1.2 wt. % P2 system in 2 wt. % KCl at 100° C.

FIG. 34 depicts the effect of 2 gpt WNE-363, 0.05 gpt BioClear 2000, 3 gpt WGS-160L, and 2 gpt WCS-631LC on 1.2 wt. % P2 system in 2 wt. % KCl at 100° C.

FIG. 35 depicts the effect of 0.6% WCS-631LC on 0.5 wt. % P1-P5 systems in 2 wt. % KCl at room temperature.

FIG. 36 depicts a static column proppant suspension test of a P2 system at room temperature.

FIG. 37 depicts a static column proppant suspension test of a P2 system at 80° C.

### DEFINITIONS OF TERM USED IN THE INVENTION

The following definitions are provided in order to aid those skilled in the art in understanding the detailed description of the present invention.

The term “about” means that the value is within about 10% of the indicated value. In certain embodiments, the value is within about 5% of the indicated value. In certain embodiments, the value is within about 2.5% of the indicated value. In certain embodiments, the value is within about 1% of the indicated value. In certain embodiments, the value is within about 0.5% of the indicated value.

The term “substantially” means that the value is within about 10% of the indicated value. In certain embodiments, the value is within about 5% of the indicated value. In certain embodiments, the value is within about 2.5% of the indicated value. In certain embodiments, the value is within about 1% of the indicated value. In certain embodiments, the value is within about 0.5% of the indicated value.

The term “substantially free of” means that the composition includes less than 5% (weight or volume) of the indicated ingredient. In certain embodiments, the value is within about 2.5% (weight or volume) of the indicated value. In certain embodiments, the value is within about 1.0% of the indicated value. In certain embodiments, the value is within about 1% (weight or volume) of the indicated value. In certain embodiments, the value is within about 0.5% (weight or volume) of the indicated value. In certain embodiments, the value is within about 0.1% (weight or volume) of the indicated value.

The term “substantially no” means that the composition includes none of the indicated ingredient or has less than a detectable amount of the indicated ingredient.

The term “proppant pillar, proppant island, proppant cluster, proppant aggregate, or proppant agglomerate” mean that a plurality of proppant particles are aggregated, clustered, agglomerated or otherwise adhered together to form discrete structures.

The term “mobile proppant pillar, proppant island, proppant cluster, proppant aggregate, or proppant agglomerate” means proppant pillar, proppant island, proppant cluster, proppant aggregate, or proppant agglomerate that are capable of repositioning during fracturing, producing, or injecting operations.

The term “self healing proppant pillar, proppant island, proppant cluster, proppant aggregate, or proppant agglomerate” means proppant pillar, proppant island, proppant cluster, proppant aggregate, or proppant agglomerate that are capable of being broken apart and recombining during fracturing, producing, or injecting operations.

The term “premature breaking” as used herein refers to a phenomenon in which a gel viscosity becomes diminished to an undesirable extent before all of the fluid is introduced into the formation to be fractured. Thus, to be satisfactory, the gel viscosity should preferably remain in the range from about 50% to about 75% of the initial viscosity of the gel for at least two hours of exposure to the expected operating temperature. Preferably the fluid should have a viscosity in excess of 100 centipoise (cP) at 100 sec⁻¹ while injection into the reservoir as measured on a Fann 50 C viscometer in the laboratory.

The term “complete breaking” as used herein refers to a phenomenon in which the viscosity of a gel is reduced to such a level that the gel can be flushed from the formation by the flowing formation fluids or that it can be recovered by a swabbing operation. In laboratory settings, a completely broken, non-crosslinked gel is one whose viscosity is about 10 cP or less as measured on a Model 35 Fann viscometer having a R1B1 rotor and bob assembly rotating at 300 rpm.

The term “amphoteric” refers to surfactants that have both positive and negative charges. The net charge of the surfactant can be positive, negative, or neutral, depending on the pH of the solution.

The term “anionic” refers to those viscoelastic surfactants that possess a net negative charge.

The term “fracturing” refers to the process and methods of breaking down a geological formation, i.e. the rock formation around a well bore, by pumping fluid at very high pressures, in order to increase production rates from a hydrocarbon reservoir. The fracturing methods of this invention use otherwise conventional techniques known in the art.

The term “proppant” refers to a granular substance suspended in the fracturing fluid during the fracturing operation, which serves to keep the formation from closing back down upon itself once the pressure is released. Proppants envisioned by the present invention include, but are not limited to, conventional proppants familiar to those skilled in the art such as sand, 20-40 mesh sand, resin-coated sand, sintered bauxite, glass beads, and similar materials.

The abbreviation “RPM” refers to relative permeability modifiers.

The term “surfactant” refers to a soluble, or partially soluble compound that reduces the surface tension of liquids, or reduces inter-facial tension between two liquids, or a liquid and a solid by congregating and orienting itself at these interfaces.

The term “viscoelastic” refers to those viscous fluids having elastic properties, i.e., the liquid at least partially returns to its original form when an applied stress is released.

The phrase “viscoelastic surfactants” or “VES” refers to that class of compounds which can form micelles (spherulitic, anisometric, lamellar, or liquid crystal) in the presence of counter ions in aqueous solutions, thereby imparting viscosity to the fluid. Anisometric micelles in particular are preferred, as their behavior in solution most closely resembles that of a polymer.

The abbreviation “VAS” refers to a Viscoelastic Anionic Surfactant, useful for fracturing operations and frac packing. As discussed herein, they have an anionic nature with preferred counterions of potassium, ammonium, sodium, calcium or magnesium.

The term “foamable” means a composition that when mixed with a gas forms a stable foam.

The term “fracturing layer” is used to designate a layer, or layers, of rock that are intended to be fractured in a single fracturing treatment. It is important to understand that a “fracturing layer” may include one or more than one of rock layers or strata as typically defined by differences in permeability, rock type, porosity, grain size, Young's modulus, fluid content, or any of many other parameters. That is, a “fracturing layer” is the rock layer or layers in contact with all the perforations through which fluid is forced into the rock in a given treatment. The operator may choose to fracture, at one time, a “fracturing layer” that includes water zones and hydrocarbon zones, and/or high permeability and low permeability zones (or even impermeable zones such as shale zones) etc. Thus a “fracturing layer” may contain multiple regions that are conventionally called individual layers, strata, zones, streaks, pay zones, etc., and we use such terms in their conventional manner to describe parts of a fracturing layer. Typically the fracturing layer contains a hydrocarbon reservoir, but the methods may also be used for fracturing water wells, storage wells, injection wells, etc. Note also that some embodiments of the invention are described in terms of conventional circular perforations (for example, as created with shaped charges), normally having perforation tunnels. However, the invention is may also be practiced with other types of “perforations”, for example openings or slots cut into the tubing by jetting.

The term “gpt” means gallons per thousand gallons.

The term “ppt” means pounds per thousand gallons.

### DETAILED DESCRIPTION OF THE INVENTION

The inventors have found that downhole fluids may be formulated using synthetic hydratable polymers replacing natural hydratable polymers so that the compositions are substantially free of natural occurring hydratable polymers or include no natural occurring hydratable polymers. The inventors have found that the use of synthetic hydratable polymers in place of natural hydratable polymers has many advantages, because synthetic hydratable polymers are governed by crude oil prices meaning that fluctuations in price will be less dramatic and supply of materials will be more dependable compared to natural sources, which are somewhat unpredictable.

### Synthetic Polymer Compositions

Embodiments of the present invention broadly relate to synthetic polymer compositions including a major amount of synthetic hydratable polymers for use in fracturing fluids, where the synthetic polymer compositions are capable of increasing the viscosity of aqueous base fluids and of being broken using one breaker or a plurality of breakers, where the major amount is greater than or equal to 80 wt. % or between 80 wt. % up to 100 wt. %, and a minor amount of natural hydratable polymers. In certain embodiments, the synthetic polymer compositions include between 85 wt. % and 100 wt. % of synthetic hydratable polymers. In certain embodiments, the synthetic polymer compositions include between 95 wt. % and 100 wt. % of synthetic hydratable polymers. In certain embodiments, the synthetic polymer compositions include between 99 wt. % and 100 wt. % of synthetic hydratable polymers. In certain embodiments, the synthetic polymer compositions include 100 wt. % of synthetic hydratable polymers. In certain embodiments, the synthetic polymer compositions are substantially free of natural hydratable polymers. In certain embodiments, the synthetic polymer compositions include substantially no natural hydratable polymers. The synthetic hydratable polymers are selected from the group consisting of (a) high molecular weight homo- and/or copolymers of acrylic acid crosslinked with polyalkenyl polyethers, (b) high molecular weight hydrophobically modified, cross-linked polyacrylate polymers, (c) hydrophilic, anionic, high molecular weight, cross-linked polyacrylic acid polymers, and (d) mixtures or combinations thereof. In certain embodiment, the fracturing fluids further include proppants.

Embodiments of this invention relate to synthetic polymer compositions including a major amount of synthetic hydratable polymers, and a minor amount of natural hydratable polymers, where the synthetic hydratable polymers are selected from the group consisting of (a) high molecular weight homo- and/or copolymers of acrylic acid crosslinked with polyalkenyl polyethers, (b) high molecular weight hydrophobically modified, cross-linked polyacrylate polymers, (c) hydrophilic, anionic, high molecular weight, cross-linked polyacrylic acid polymers, and (d) mixtures or combinations thereof, where the natural hydratable polymest are selected from the group consisting of polysaccharides, polyacrylamides, polyacrylamide copolymers, and mixtures or combinations thereof, where the polymer composition builds viscosity after being combined with an aqueous base fluid and breaks using one breaker or a plurality of breakers, and where the major amount is between 80 wt. % up to 100 wt. % and the minor amount is between 0 wt. % and 20 wt. %. In certain embodiments, the major amount is between 85 wt. % and 100 wt. % of synthetic hydratable polymers and the minor amount is between 0 wt. % and 15 wt. %. In certain embodiments, the major amount is between 90 wt. % and 100 wt. % of synthetic hydratable polymers and the minor amount is between 0 wt. % and 10 wt. %. In certain embodiments, the major amount is between 95 wt. % and 100 wt. % of synthetic hydratable polymers and the minor amount is between 0 wt. % and 5 wt. %. In other embodiments, the major amount between 99 wt. % and 100 wt. % of synthetic hydratable polymers and the minor amount is between 0 wt. % and 1 wt. %. In other embodiments, the composition is substantially free of natural hydratable polymers or include substantially no natural hydratable polymers. In other embodiments, the polysaccharides include galactomannan gum and cellulose derivatives. In other embodiments, the polysaccharides include guar gum, locust bean gum, carboxymethylguar, hydroxyethylguar, hydroxypropylguar, carboxymethylhydroxypropylguar, carboxymethylhydroxyethylguar, hydroxymethyl cellulose, carboxymethylhydroxyethyl cellulose, and hydroxyethyl cellulose and mixtures or combinations thereof.

### Fracturing Fluids

Embodiments of the present invention broadly relate to fracturing fluids including a base fluid and an effective amount of a synthetic polymer composition including a major amount of synthetic hydratable polymers and a minor amount of natural hydratable polymers, where the synthetic polymer compositions are capable of increasing the viscosity of the base fluids after addition and of being broken using one breaker or a plurality of breakers, where the major amount is between 80 wt. % up and 100 wt. % and the minor amount is between 0 wt. % and 20 wt. %. In certain embodiments, the synthetic polymer compositions include 100 wt. % of synthetic hydratable polymers. The synthetic hydratable polymers selected from the group consisting of (a) high molecular weight homo- and/or copolymers of acrylic acid crosslinked with polyalkenyl polyethers, (b) high molecular weight hydrophobically modified, cross-linked polyacrylate polymers, (c) hydrophilic, anionic, high molecular weight, cross-linked polyacrylic acid polymers, and (d) mixtures or combinations thereof. In other embodiments, the fracturing fluids further include other additives to modify the behavior of the fracturing fluids. In other embodiments, the fracturing fluids further include a breaker composition capable of breaking the fracturing fluid in a controlled manner. In other embodiments, the fracturing fluids further include a crosslinking system to build viscosity. In certain embodiments, the effective amount of the synthetic polymer composition is between 0.1 wt. % and about 10 wt. % of the entire fracturing fluid. In certain embodiments, the effective amount of the synthetic polymer composition is between 0.5 wt. % and about 5 wt. % of the entire fracturing fluid. In certain embodiments, the effective amount of the synthetic polymer composition is between 1.0 wt. % and about 2.5 wt. % of the entire fracturing fluid.

Embodiments of this invention relate to fracturing fluid compositions including a base fluid and an effective amount of a synthetic polymer composition including a major amount of synthetic hydratable polymers and a minor amount of a natural hydratable polymers, where the synthetic hydratable polymers are selected from the group consisting of (a) high molecular weight homo- and/or copolymers of acrylic acid crosslinked with polyalkenyl polyethers, (b) high molecular weight hydrophobically modified, cross-linked polyacrylate polymers, (c) hydrophilic, anionic, high molecular weight, cross-linked polyacrylic acid polymers, and (d) mixtures or combinations thereof, where the natural hydratable polymest are selected from the group consisting of polysaccharides, polyacrylamides, polyacrylamide copolymers, and mixtures or combinations thereof, where the polymer composition builds viscosity after being combined with an aqueous base fluid and breaks using one breaker or a plurality of breakers, where the major amount is between 80 wt. % up to 100 wt. %, where the minor amount is between 0 wt. % and 20 wt. %, and where the effective amount of the synthetic polymer composition is between 0.1 wt. % and about 10 wt. % of the entire fracturing fluid. In certain embodiments, the compositions further include proppants. In other embodiments, the compositions further include modifying additives to modify the behavior of the fracturing fluids. In other embodiments, the compositions further include a breaker composition capable of breaking the fracturing fluid in a controlled manner. In other embodiments, the compositions further include a crosslinking system to build viscosity. In other embodiments, the effective amount of the synthetic polymer composition is between 0.1 wt. % and about 5 wt. % of the entire fracturing fluid. In other embodiments, the effective amount of the synthetic polymer composition is between 0.1 wt. % and about 2.5 wt. % of the entire fracturing fluid. In other embodiments, the major amount is between 85 wt. % and 100 wt. % of synthetic hydratable polymers and the minor amount is between 0 wt. % and 15 wt. %. In other embodiments, the major amount is between 90 wt. % and 100 wt. % of synthetic hydratable polymers and the minor amount is between 0 wt. % and 10 wt. %. In other embodiments, the major amount is between 95 wt. % and 100 wt. % of synthetic hydratable polymers and the minor amount is between 0 wt. % and 5 wt. %. In other embodiments, the major amount between 99 wt. % and 100 wt. % of synthetic hydratable polymers and the minor amount is between 0 wt. % and 1 wt. %. In other embodiments, the composition is substantially free of natural hydratable polymers or include substantially no natural hydratable polymers. In other embodiments, the polysaccharides include galactomannan gum and cellulose derivatives. In other embodiments, the polysaccharides include guar gum, locust bean gum, carboxymethylguar, hydroxyethylguar, hydroxypropylguar, carboxymethylhydroxypropylguar, carboxymethylhydroxyethylguar, hydroxymethyl cellulose, carboxymethylhydroxyethyl cellulose, and hydroxyethyl cellulose and mixtures or combinations thereof.

### Methods for Preparing Fracturing Fluids

Embodiments of the present invention broadly relate to methods for making fracturing fluids including combining a base fluid and an effective amount of a synthetic polymer composition under condition sufficient to form a fracturing fluid having a desired viscosity profile and a desired breaker profile. The synthetic polymer compositions include a major amount of synthetic hydratable polymers and a minor amount of natural hydratable polymers, where the synthetic polymer compositions are capable of increasing the viscosity of the base fluids after addition and of being broken using one breaker or a plurality of breakers, where the major amount is between 80 wt. % up to 100 wt. % and the minor amount is between 0 wt. % and 20 wt. %. In certain embodiments, the synthetic polymer compositions include 100 wt. % of synthetic hydratable polymers. The synthetic polymer compositions are capable of increasing a viscosity of the base fluid to the desired viscosity profile and being broken using one breaker or a plurality of breakers producing the desired breaking profile. In certain embodiments, the methods include adding a synthetic hydratable polymer composition to the base fluid before or during injection of the base fluid downhole. In certain embodiments, the synthetic hydratable polymers selected from the group consisting of (a) high molecular weight homo- and/or copolymers of acrylic acid crosslinked with polyalkenyl polyethers, (b) high molecular weight hydrophobically modified, cross-linked polyacrylate polymers, (c) hydrophilic, anionic, high molecular weight, cross-linked polyacrylic acid polymers, and (d) mixtures or combinations thereof. In certain embodiment, the fracturing fluids further include proppants. In other embodiments, the fracturing fluids further include other additives to modify the behavior of the fracturing fluids. In other embodiments, the fracturing fluids further include a breaker composition capable of breaking the fracturing fluid in a controlled manner. In other embodiments, the fracturing fluids further include a crosslinking system to build viscosity.

Embodiments of this invention relate to methods for making fracturing fluids including combining a base fluid and an effective amount of a synthetic polymer composition under condition sufficient to form a fracturing fluid having a desired viscosity profile and a desired breaker profile, where the synthetic hydratable polymers are selected from the group consisting of (a) high molecular weight homo- and/or copolymers of acrylic acid crosslinked with polyalkenyl polyethers, (b) high molecular weight hydrophobically modified, cross-linked polyacrylate polymers, (c) hydrophilic, anionic, high molecular weight, cross-linked polyacrylic acid polymers, and (d) mixtures or combinations thereof, where the natural hydratable polymest are selected from the group consisting of polysaccharides, polyacrylamides, polyacrylamide copolymers, and mixtures or combinations thereof, where the synthetic polymer compositions include a major amount of synthetic hydratable polymers and a minor amount of a natural hydratable polymers, where the synthetic polymer compositions are capable of increasing the viscosity of the base fluids after addition and of being broken using one breaker or a plurality of breakers, and where the major amount is between 80 wt. % up to 100 wt. %. In certain embodiments, the methods further include combining proppants into the fracturing fluid. In other embodiments, the methods further include combining modifying additives into the fracturing fluid to modify the behavior of the fracturing fluids. In other embodiments, the methods further include combining a breaker composition into the fracturing fluid capable of breaking the fracturing fluid in a controlled manner. In other embodiments, the methods further include combining a crosslinking system into the fracturing fluid to build viscosity. In other embodiments, the effective amount of the synthetic polymer composition is between 0.1 wt. % and about 10 wt. % of the entire fracturing fluid. In other embodiments, the effective amount of the synthetic polymer composition is between 0.5 wt. % and about 5 wt. % of the entire fracturing fluid. In other embodiments, the effective amount of the synthetic polymer composition is between 1.0 wt. % and about 2.5 wt. % of the entire fracturing fluid. In other embodiments, the major amount is between 85 wt. % and 100 wt. % of synthetic hydratable polymers and the minor amount is between 0 wt. % and 15 wt. %. In other embodiments, the major amount is between 90 wt. % and 100 wt. % of synthetic hydratable polymers and the minor amount is between 0 wt. % and 10 wt. %. In other embodiments, the major amount is between 95 wt. % and 100 wt. % of synthetic hydratable polymers and the minor amount is between 0 wt. % and 5 wt. %. In other embodiments, the major amount between 99 wt. % and 100 wt. % of synthetic hydratable polymers and the minor amount is between 0 wt. % and 1 wt. %. In other embodiments, the composition is substantially free of natural hydratable polymers or include substantially no natural hydratable polymers. In other embodiments, the polysaccharides include galactomannan gum and cellulose derivatives. In other embodiments, the polysaccharides include guar gum, locust bean gum, carboxymethylguar, hydroxyethylguar, hydroxypropylguar, carboxymethylhydroxypropylguar, carboxymethylhydroxyethylguar, hydroxymethyl cellulose, carboxymethylhydroxyethyl cellulose, and hydroxyethyl cellulose and mixtures or combinations thereof.

### Methods for Fracturing Formations

Embodiments of the present invention broadly relate to methods for fracturing a formation or formation zone using fracturing fluids including a base fluid and an effective amount of a synthetic polymer composition under condition sufficient to form a fracturing fluid having a desired viscosity profile and a desired breaker profile. The synthetic polymer compositions include a major amount of synthetic hydratable polymers and a minor amount of natural hydratable polymers. The synthetic polymer compositions are used in hydratable fracturing fluids or other high viscosity fluid that build viscosity after being combined with an aqueous base fluid and are capable of being broken using conventional breakers. The methods include injecting a fracturing fluid into a formation under fracturing conditions, where the synthetic hydratable polymer composition is added to the base fluid before or during injection of the base fluid downhole. The major amount is between 80 wt. % up to 100 wt. % and the minor amount is between 0 wt. % and 20 wt. %. In certain embodiments, the synthetic polymer compositions include 100 wt. % of synthetic hydratable polymers. In certain embodiments, the synthetic hydratable polymers selected from the group consisting of (a) high molecular weight homo- and/or copolymers of acrylic acid crosslinked with polyalkenyl polyethers, (b) high molecular weight hydrophobically modified, cross-linked polyacrylate polymers, (c) hydrophilic, anionic, high molecular weight, cross-linked polyacrylic acid polymers, and (d) mixtures or combinations thereof. In certain embodiment, the fracturing fluids further include proppants. In certain embodiment, the fracturing fluids further include proppants. In other embodiments, the fracturing fluids further include other additives to modify the behavior of the fracturing fluids. In other embodiments, the fracturing fluids further include a breaker composition capable of breaking the fracturing fluid in a controlled manner. In other embodiments, the fracturing fluids further include a crosslinking system to build viscosity.

Embodiments of this invention relate to methods for fracturing a formation or formation zone using fracturing fluids including injecting a fracturing fluid into a formation under fracturing conditions, where the fracturing fluid includes a base fluid and an effective amount of a synthetic polymer composition including a major amount of synthetic hydratable polymers and a minor amount of a natural hydratable polymers, where the synthetic hydratable polymers are selected from the group consisting of (a) high molecular weight homo- and/or copolymers of acrylic acid crosslinked with polyalkenyl polyethers, (b) high molecular weight hydrophobically modified, cross-linked polyacrylate polymers, (c) hydrophilic, anionic, high molecular weight, cross-linked polyacrylic acid polymers, and (d) mixtures or combinations thereof, where the natural hydratable polymest are selected from the group consisting of polysaccharides, polyacrylamides, polyacrylamide copolymers, and mixtures or combinations thereof, where the polymer composition builds viscosity after being combined with the base fluid and breaks using one breaker or a plurality of breakers, where the major amount is between 80 wt. % up to 100 wt. % and the minor amount is between 0 wt. % and 20 wt. %, where the effective amount of the synthetic polymer composition is between 0.1 wt. % and about 10 wt. % of the entire fracturing fluid, and where the fracturing fluid has a desired viscosity profile and a desired breaker profile. In certain embodiments, the methods further include injecting a proppant fluid including proppants into the formation under propping conditions. In other embodiments, the fracturing fluid further includes proppants. In other embodiments, the fracturing fluid further includes modifying additives to modify the behavior of the fracturing fluids. In other embodiments, the fracturing fluid further includes a breaker composition capable of breaking the fracturing fluid in a controlled manner. In other embodiments, the fracturing fluid further includes a crosslinking system into the fracturing fluid to build viscosity. In other embodiments, the effective amount of the synthetic polymer composition is between 0.5 wt. % and about 5 wt. % of the entire fracturing fluid. In other embodiments, the effective amount of the synthetic polymer composition is between 1.0 wt. % and about 2.5 wt. % of the entire fracturing fluid. In other embodiments, the major amount is between 85 wt. % and 100 wt. % of synthetic hydratable polymers and the minor amount is between 0 wt. % and 15 wt. %. In other embodiments, the major amount is between 90 wt. % and 100 wt. % of synthetic hydratable polymers and the minor amount is between 0 wt. % and 10 wt. %. In other embodiments, the major amount is between 95 wt. % and 100 wt. % of synthetic hydratable polymers and the minor amount is between 0 wt. % and 5 wt. %. In other embodiments, the major amount between 99 wt. % and 100 wt. % of synthetic hydratable polymers and the minor amount is between 0 wt. % and 1 wt. %. In other embodiments, the composition is substantially free of natural hydratable polymers or include substantially no natural hydratable polymers. In other embodiments, the polysaccharides include galactomannan gum and cellulose derivatives. In other embodiments, the polysaccharides include guar gum, locust bean gum, carboxymethylguar, hydroxyethylguar, hydroxypropylguar, carboxymethylhydroxypropylguar, carboxymethylhydroxyethylguar, hydroxymethyl cellulose, carboxymethylhydroxyethyl cellulose, and hydroxyethyl cellulose and mixtures or combinations thereof.

### Suitable Reagents

### Synthetic Hydratable Polymers

Suitable synthetic hydratable polymers include, without limitation, (a) high molecular weight homo- and/or copolymers of acrylic acid crosslinked with polyalkenyl polyethers, (b) high molecular weight hydrophobically modified, cross-linked polyacrylate polymers, (c) hydrophilic, anionic, high molecular weight, cross-linked polyacrylic acid polymers, and (d) mixtures or combinations thereof.

In certain embodiments, the cross-linked polyacrylate polymer used in this invention have a minimum Brookfield RVF or RVT Viscosity, (mPa·s) (20 rpm at 25° C., neutralized solutions) of 19,000 and a maximum viscosity of 35,000 for a 0.2 wt. % solution. In other embodiments, the cross-linked polyacrylate polymer used in this invention have a minimum viscosity of 40,000 and a maximum viscosity of 60,000 for a 0.5 wt. % solution. In other embodiments, the cross-linked polyacrylate polymer used in this invention have a minimum viscosity of 45,000 and a maximum viscosity of 80,000 for a 1.0 wt. % solution. In other embodiments, the cross-linked polyacrylate polymer used in this invention have a minimum Brookfield RVF or RVT Viscosity, (mPa·s) (20 rpm at 25° C., neutralized solutions) of 13,000 and a maximum viscosity of 30,000 for a 0.2 wt. % solution. In other embodiments, the cross-linked polyacrylate polymer used in this invention have a minimum viscosity of 40,000 and a maximum viscosity of 60,000 for a 0.5 wt. % solution. In certain embodiments, the cross hydrophobically modified, crosslinked polyacrylate polymer used in this invention have a minimum Brookfield RVT viscosity (mPa·s) (20 rpm @ 25° C., spindle #7) of 47,000 and a maximum viscosity of 67,000 for a 1.0 wt % solution neutralized to a pH between 6.0 and 6.3. In other embodiments, the hydrophobically modified crosslinked polyacrylate polymer used in this invention have a minimum Brookfield RVT viscosity (mPa·s) (20 rpm @ 25° C., spindle #7) of 45,000 and a maximum viscosity of 65,000 for a 0.5 wt % solution neutralized to a pH between 6.0 and 6.3. In other embodiments, the crosslinked acrylic acid homopolymer used in this invention have a minimum Brookfield RVT viscosity (mPa·s) (20 rpm @ 25° C., spindle #7) of 50,000 and a maximum viscosity of 70,000 for a 0.5 wt % solution neutralized to a pH between 6.0 and 6.3.

Exemplary synthetic rheology modifiers include acrylic based polymers and copolymers. One class of acrylic based rheology modifiers are the carboxyl functional alkali-swellable and alkali-soluble thickeners (ASTs) produced by the free-radical polymerization of acrylic acid alone or in combination with other ethylenically unsaturated monomers. The polymers can be synthesized by solvent/precipitation as well as emulsion polymerization techniques. Exemplary synthetic rheology modifiers of this class include homopolymers of acrylic acid or methacrylic acid and copolymers polymerized from one or more monomers of acrylic acid, substituted acrylic acid, and C₁-C₃₀ alkyl esters of acrylic acid and methacrylic acid. Optionally, other ethylenically unsaturated monomers such as, for example, styrene, vinyl acetate, ethylene, butadiene, acrylonitrile, as well as mixtures thereof can be copolymerized into the backbone. The foregoing polymers are crosslinked by a monomer that contains two or more moieties that contain ethylenic unsaturation. In one aspect, the crosslinker is selected from a polyalkenyl polyether of a polyhydric alcohol containing at least two alkenyl ether groups per molecule. Other Exemplary crosslinkers are selected from but not limited to allyl ethers of sucrose and allyl ethers of pentaerythritol, and mixtures thereof. These polymers are more fully described in U.S. Pat. No. 5,087,445; U.S. Pat. No. 4,509,949; and U.S. Pat. No. 2,798,053.

In one aspect, the AST rheology modifier or thickener is a crosslinked homopolymer polymerized from acrylic acid or methacrylic acid and is generally referred to under the INCI name of Carbomer. Commercially available Carbomers include Carbopol® polymers 934, 940, 941, 956, 980, and 996 available from Lubrizol Advanced Materials, Inc.

In a further aspect, the rheology modifier is selected from a crosslinked copolymer polymerized from a first monomer selected from one or more monomers of acrylic acid, methacrylic acid and a second monomer selected from one or more C₁₀-C₃₀ alkyl acrylate esters of acrylic acid or methacrylic acid. In one aspect, the monomers can be polymerized in the presence of a steric stabilizer such as disclosed in U.S. Pat. No. 5,288,814 which is herein incorporated by reference. Some of the forgoing polymers are designated under INCI nomenclature as Acrylates/C10-30 Alkyl Acrylate Crosspolymer and are commercially available under the trade names Carbopol® 1342 and 1382, Carbopol® Ultrez 20 and 21, Carbopol® ETD 2020, and Pemulen® TR-1 and TR-2 from Lubrizol Advanced Materials, Inc. Other acrylic copolymer rheology modifiers marketed by Lubrizol Advanced Materials, Inc. are available under the Carbopol® EZ series trade name.

The crosslinked carboxyl group containing homopolymers and copolymers of the invention have weight average molecular weights ranging from at least 1 million to billions of Daltons in one aspect and from about 1.5 to about 4.5 billion Daltons in another aspect (see TDS-222, Oct. 15, 2007, Lubrizol Advanced Materials, Inc., which is herein incorporated by reference).

Exemplary examples of suitable synthetic hydratable polymers include, without, limitation, CARBOPOL® Aqua SF-1 Polymer (acrylates copolymer), CARBOPOL® Aqua SF-2 Polymer (acrylates crosspolymer-4), CARBOPOL® Aqua CC Polymer (polyacrylate-1 crosspolymer), CARBOPOL® 934 Polymer (carbomer), CARBOPOL® 940 Polymer (carbomer), CARBOPOL® 941 Polymer (carbomer), CARBOPOL® 980 Polymer (carbomer), CARBOPOL® 981 Polymer (carbomer), CARBOPOL® 1342 Polymer (acrylates/C₁₀₋₃₀ alkyl acrylate crosspolymer), CARBOPOL® 1382 Polymer (acrylates/C₁₀₋₃₀ alkyl acrylate crosspolymer), CARBOPOL® 2984 Polymer (carbomer), CARBOPOL® 5984 Polymer (carbomer), CARBOPOL® Ultrez 10 Polymer (carbomer), CARBOPOL® Ultrez 20 Polymer (acrylates/C₁₀₋₃₀ alkyl acrylate crosspolymer), CARBOPOL® Ultrez 21 Polymer (acrylates/C₁₀₋₃₀ alkyl acrylate crosspolymer), CARBOPOL® Ultrez 30 Polymer (carbomer), CARBOPOL® ETD 2020 Polymer (acrylates/C₁₀₋₃₀ alkyl acrylate crosspolymer), CARBOPOL® ETD 2050 Polymer (carbomer), CARBOPOL® 674 Polymer, CARBOPOL® 676 Polymer, CARBOPOL® 690 Polymer, CARBOPOL® ETD 2623 Polymer, CARBOPOL® ETD 2691 Polymer, CARBOPOL® EZ-2 Polymer, CARBOPOL® EZ-3 Polymer, CARBOPOL® EZ-4 Polymer, CARBOPOL® Aqua 30 Polymer, and mixtures or combinations thereof, where these polymers are available from The Lubrizol Corporation and Ashland™ 941 CARBOMER, Ashland™ 981 CARBOMER, Ashland™ 980 CARBOMER (acrylic acid polymer), Ashland™ 940 CARBOMER, and mixtures or combinations thereof, where these polymers are available from Ashland Inc and Lubrizol Corporation.

### Natural Hydratable Polymers

Suitable natural hydratable water soluble polymers for use in fracturing fluids of this invention include, without limitation, polysaccharides and mixtures or combinations thereof. Suitable polysaccharides include galactomannan gum and cellulose derivatives. In certain embodiments, the polysaccharides include guar gum, locust bean gum, carboxymethylguar, hydroxyethylguar, hydroxypropylguar, carboxymethylhydroxypropylguar, carboxymethylhydroxyethylguar, hydroxymethyl cellulose, carboxymethylhydroxyethyl cellulose, and hydroxyethyl cellulose and mixtures or combinations thereof.

The natural hydratable polymer useful in the present invention can be any of the hydratable polysaccharides having galactose or mannose monosaccharide components and are familiar to those in the well service industry. These polysaccharides are capable of gelling in the presence of a crosslinking agent to form a gelled based fluid. For instance, suitable hydratable polysaccharides are the galactomannan gums, guars and derivatized guars. Specific examples are guar gum and guar gum derivatives. Suitable gelling agents are guar gum, hydroxypropyl guar and carboxymethyl hydroxypropyl guar. In certain embodiment, the hydratable polymers for the present invention are guar gum and carboxymethyl hydroxypropyl guar and hydroxypropyl guar. Other exemplary fracturing fluid formulations are disclosed in U.S. Pat. Nos. 5,201,370 and 6,138,760, which are incorporated herein by reference.

### Proppants

The proppant type can be sand, intermediate strength ceramic proppants (available from Carbo Ceramics, Norton Proppants, etc.), sintered bauxites and other materials known to the industry. Any of these base propping agents can further be coated with a resin (available from Santrol, a Division of Fairmount Industries, Borden Chemical, etc.) to potentially improve the clustering ability of the proppant. In addition, the proppant can be coated with resin or a proppant flowback control agent such as fibers for instance can be simultaneously pumped. By selecting proppants having a contrast in one of such properties such as density, size and concentrations, different settling rates will be achieved.

Propping agents or proppants are typically added to the fracturing fluid prior to the addition of a crosslinking agent. However, proppants may be introduced in any manner which achieves the desired result. Any proppant may be used in embodiments of the invention. Examples of suitable proppants include, but are not limited to, quartz sand grains, glass and ceramic beads, walnut shell fragments, aluminum pellets, nylon pellets, and the like. Proppants are typically used in concentrations between about 1 to 8 lbs. per gallon of a fracturing fluid, although higher or lower concentrations may also be used as desired. The fracturing fluid may also contain other additives, such as surfactants, corrosion inhibitors, mutual solvents, stabilizers, paraffin inhibitors, tracers to monitor fluid flow back, and so on.

Besides the proppant concentrations in the final formulation, the particles sizes of the proppants are also a factor in the performance of the fluids of this invention. In certain embodiments, the proppants have sizes of 16/20 mesh, 16/30 mesh, 20/40 mesh and mixtures and combinations thereof. In addition, proppant density is another factor in the performance of the fluids of this invention. Exemplary examples of the proppants useful in this invention include, without limitation, CARBO-HSP® 16/30 mesh and 20/40 mesh having a bulk density=2 g/cm³ and CARBO-LITE® 16/20 mesh and 20/40 mesh having a bulk density=1.57 g/cm³, and mixtures or combinations thereof.

### Cross-Linking Agents

Suitable cross-linking agent for use in this invention when the compositions include minor amount of natural hydratatable polymers include, without limitation, any suitable cross-linking agent for use with the gelling agents. Exemplary cross-linking agents include, without limitation, di- and tri-valent metal salts such as calcium salts, magnesium salts, barium salts, copperous salts, cupric salts, ferric salts, aluminum salts, or mixtures or combinations thereof.

A suitable crosslinking agent can be any compound that increases the viscosity of the fluid by chemical crosslinking, physical crosslinking, or any other mechanisms. For example, the gellation of a hydratable polymer can be achieved by crosslinking the polymer with metal ions including boron in combination with zirconium, and titanium containing compounds. The amount of the crosslinking agent used also depends upon the well conditions and the type of treatment to be effected, but is generally in the range of from about 0.001 wt. % to about 2 wt. % of metal ion of the crosslinking agent in the hydratable polymer fluid. In some applications, the aqueous polymer solution is crosslinked immediately upon addition of the crosslinking agent to form a highly viscous gel. In other applications, the reaction of the crosslinking agent can be retarded so that viscous gel formation does not occur until the desired time.

When the synthetic hydratable compositions of this invention include no or substantially no natural hydratable polymers, then viscosity may be increased solely by the addition of a sufficient amount of an aqueous alkali solution to the compositions. When pH goes up to about pH 6 to about pH 10, the viscosity is increased due to the ionization of carboxylic acid group and the formation of ionic interactions with metal ions.

The boron based crosslinking agents may be selected from the group consisting of boric acid, sodium tetraborate, and mixtures thereof. These are described in U.S. Pat. No. 4,514,309. In some embodiments, the well treatment fluid composition may further comprise a proppant.

### Breakers

The term “breaking agent” or “breaker” refers to any chemical that is capable of reducing the viscosity of a gelled fluid. As described above, after a fracturing fluid is formed and pumped into a subterranean formation, it is generally desirable to convert the highly viscous gel to a lower viscosity fluid. This allows the fluid to be easily and effectively removed from the formation and to allow desired material, such as oil or gas, to flow into the well bore. This reduction in viscosity of the treating fluid is commonly referred to as “breaking” Consequently, the chemicals used to break the viscosity of the fluid is referred to as a breaking agent or a breaker. In certain embodiments, the breaker is a salt or a brine solution. In other embodiments, the breaker is an encapsulated salt, where the encapsulating material is designed to degrade after a desire time of exposure to a base fluid or by the addition of an agent that disrupts the encapsulating material releasing the salt. In other embodiments, the breaker is a brine added to the fracturing fluid in an amount sufficient to break the viscosity of the fracturing fluid. The brines may be any brine solution including sodium chloride brines, calcium chloride brines, or other brines capable of reducing the viscosity of the synthetic hydratable polymers used in the fracturing fluids of this invention.

There are various methods available for breaking a fracturing fluid or a treating fluid. Typically, fluids break after the passage of time and/or prolonged exposure to high temperatures. However, it is desirable to be able to predict and control the breaking within relatively narrow limits. Mild oxidizing agents are useful as breakers when a fluid is used in a relatively high temperature formation, although formation temperatures of 300° F. (149° C.) or higher will generally break the fluid relatively quickly without the aid of an oxidizing agent.

Examples of inorganic breaking agents for use in this invention include, but are not limited to, persulfates, percarbonates, perborates, peroxides, perphosphates, permanganates, etc. Specific examples of inorganic breaking agents include, but are not limited to, alkaline earth metal persulfates, alkaline earth metal percarbonates, alkaline earth metal perborates, alkaline earth metal peroxides, alkaline earth metal perphosphates, zinc salts of peroxide, perphosphate, perborate, and percarbonate, and so on. Additional suitable breaking agents are disclosed in U.S. Pat. Nos. 5,877,127; 5,649,596; 5,669,447; 5,624,886; 5,106,518; 6,162,766; and 5,807,812, incorporated herein by reference. In some embodiments, an inorganic breaking agent is selected from alkaline earth metal or transition metal-based oxidizing agents, such as magnesium peroxides, zinc peroxides, and calcium peroxides.

In addition, enzymatic breakers may also be used in place of or in addition to a non-enzymatic breaker. Examples of suitable enzymatic breakers such as guar specific enzymes, alpha and beta amylases, amyloglucosidase, aligoglucosidase, invertase, maltase, cellulase, and hemi-cellulase are disclosed in U.S. Pat. Nos. 5,806,597 and 5,067,566, incorporated herein by reference.

A breaking agent or breaker may be used “as is” or be encapsulated and activated by a variety of mechanisms including crushing by formation closure or dissolution by formation fluids. Such techniques are disclosed, for example, in U.S. Pat. Nos. 4,506,734; 4,741,401; 5,110,486; and 3,163,219, incorporated herein by reference.

The above breaker may also be encapsulated in a polymeric coating that decomposes in the fluids at a predetermined or known rate so that the breaker are release into the system only after the encapsulation agent decomposes or the capsules break under downhole conditions.

Suitable ester compounds include any ester which is capable of assisting the breaker in degrading the viscous fluid in a controlled manner, i.e., providing delayed breaking initially and substantially complete breaking after well treatment is completed. An ester compound is defined as a compound that includes one or more carboxylate groups: R—COO—, wherein R is phenyl, methoxyphenyl, alkylphenyl, C₁-C₁₁ alkyl, C₁-C₁₁ substituted alkyl, substituted phenyl, or other organic radicals. Suitable esters include, but are not limited to, diesters, triesters, etc.

An ester is typically formed by a condensation reaction between an alcohol and an acid by eliminating one or more water molecules. Ester may hydrolyze to regenerate the organic acid, which reduces the pH of the fluid, thus decreasing a viscosity of fluid including the synthetic hydratable polymers. Other degradable polymers can be used such as PLA, PGA as delayed acid generator. Since they are solid they can also behave as fluid loss agents. Preferably, the acid is an organic acid, such as a carboxylic acid. A carboxylic acid refers to any of a family of organic acids characterized as polycarboxylic acids and by the presence of more than one carboxyl group. In additional to carbon, hydrogen, and oxygen, a carboxylic acid may include heteroatoms, such as S, N, P, B, Si, F, Cl, Br, and I. In some embodiments, a suitable ester compound is an ester of oxalic, malonic, succinic, malic, tartaric, citrate, phthalic, ethylenediaminetetraacetic (EDTA), nitrilotriacetic, phosphoric acids, etc. Moreover, suitable esters also include the esters of glycolic acid. The alkyl group in an ester that comes from the corresponding alcohol includes any alkyl group, both substituted or unsubstituted. Preferably, the alkyl group has one to about ten carbon atoms per group. It was found that the number of carbon atoms on the alkyl group affects the water solubility of the resulting ester. For example, esters made from C₁-C₂ alcohols, such as methanol and ethanol, have relatively higher water solubility. Thus, application temperature range for these esters may range from about 120° F. to about 250° F. (about 49° C. to about 121° C.). For higher temperature applications, esters formed from C₃-C₁₀ alcohols, such as n-propanol, butanol, hexanol, and cyclohexanol, may be used. Of course, esters formed from C₁₁ or higher alcohols may also be used. In some embodiments, mixed esters, such as acetyl methyl dibutyl citrate, may be used for high temperature applications. Mixed esters refer to those esters made from polycarboxylic acid with two or more different alcohols in a single condensation reaction. For example, acetyl methyl dibutyl citrate may be prepared by condensing citric acid with both methanol and butanol and then followed by acylation.

Specific examples of the alkyl groups originating from an alcohol include, but are not limited to, methyl, ethyl, propyl, butyl, iso-butyl, 2-butyl, t-butyl, benzyl, p-methoxybenzyl, m-methoxybenxyl, chlorobenzyl, p-chlorobenzyl, phenyl, hexyl, pentyl, etc. Specific examples of suitable ester compounds include, but are not limited to, triethyl phosphate, diethyl oxalate, dimethyl phthalate, dibutyl phthalate, diethyl maleate, diethyl tartrate, 2-ethoxyethyl acetate, ethyl acetylacetate, triethyl citrate, acetyl triethyl citrate, tetracyclohexyl EDTA, tetra-1-octyl EDTA, tetra-n-butyl EDTA, tetrabenzyl EDTA, tetramethyl EDTA, etc. Additional suitable ester compounds are described, for example, in the following U.S. Pat. Nos. 3,990,978; 3,960,736; 5,067,556; 5,224,546; 4,795,574; 5,693,837; 6,054,417; 6,069,118; 6,060,436; 6,035,936; 6,147,034; and 6,133,205, incorporated herein by reference.

When an ester of a polycarboxylic acid is used, total esterification of the acid functionality is preferred, although a partially esterified compound may also be used in place of or in addition to a totally esterified compound. In these embodiments, phosphate esters are not used alone. A phosphate ester refers to a condensation product between an alcohol and a phosphorus acid or a phosphoric acid and metal salts thereof. However, in these embodiments, combination of a polycarboxylic acid ester with a phosphate ester may be used to assist the degradation of a viscous gel.

When esters of polycarboxylic acids, such as esters of oxalic, malonic, succinic, malic, tartaric, citrate, phthalic, ethylenediaminetetraacetic (EDTA), nitrilotriacetic, and other carboxylic acids are used, it was observed that these esters assist metal based oxidizing agents (such as alkaline earth metal or zinc peroxide) in the degradation of fracturing fluids. It was found that the addition of 0.1 L/m³ to 5 L/m³ of these esters significantly improves the degradation of the fracturing fluid. More importantly, the degradation response is delayed, allowing the fracturing fluid ample time to create the fracture and place the proppant prior to the degradation reactions. The delayed reduction in viscosity is likely due to the relatively slow hydrolysis of the ester, which forms polycarboxylate anions as hydrolysis products. These polycarboxylate anions, in turn, improve the solubility of metal based oxidizing agents by sequestering the metal associated with the oxidizing agents. This may have promoted a relatively rapid decomposition of the oxidizing agent and caused the fracturing fluid degradation.

Generally, the temperature and the pH of a fracturing fluid affects the rate of hydrolysis of an ester. For downhole operations, the bottom hole static temperature (“BHST”) cannot be easily controlled or changed. The pH of a fracturing fluid usually is adjusted to a level to assure proper fluid performance during the fracturing treatment. Therefore, the rate of hydrolysis of an ester could not be easily changed by altering BHST or the pH of a fracturing fluid. However, the rate of hydrolysis may be controlled by the amount of an ester used in a fracturing fluid. For higher temperature applications, the hydrolysis of an ester may be retarded or delayed by dissolving the ester in a hydrocarbon solvent. Moreover, the delay time may be adjusted by selecting esters that provide more or less water solubility. For example, for low temperature applications, polycarboxylic esters made from low molecular weight alcohols, such as methanol or ethanol, are recommended. The application temperature range for these esters could range from about 120° F. to about 250° F. (about 49° C. to about 121° C.). On the other hand, for higher temperature applications or longer injection times, esters made from higher molecular weight alcohols should preferably be used. The higher molecular weight alcohols include, but are not limited to, C₃-C₆ alcohols, e.g., n-propanol, hexanol, and cyclohexanol.

In some embodiments, esters of citric acid are used in formulating a well treatment fluid. A preferred ester of citric acid is acetyl triethyl citrate, which is available under the trade name Citraflex A2 from Morflex, Inc., Greensboro, N.C.

### Gases

Suitable gases for foaming the fluid of this invention include, without limitation, nitrogen, carbon dioxide, or any other gas suitable for use in formation fracturing, or mixtures or combinations thereof.

### Corrosion Inhibitors

Suitable corrosion inhibitor for use in this invention include, without limitation: quaternary ammonium salts e.g., chloride, bromides, iodides, dimethylsulfates, diethylsulfates, nitrites, bicarbonates, carbonates, hydroxides, alkoxides, or the like, or mixtures or combinations thereof; salts of nitrogen bases; or mixtures or combinations thereof. Exemplary quaternary ammonium salts include, without limitation, quaternary ammonium salts from an amine and a quaternarization agent, e.g., alkylchlorides, alkylbromide, alkyl iodides, alkyl sulfates such as dimethyl sulfate, diethyl sulfate, etc., dihalogenated alkanes such as dichloroethane, dichloropropane, dichloroethyl ether, epichlorohydrin adducts of alcohols, ethoxylates, or the like; or mixtures or combinations thereof and an amine agent, e.g., alkylpyridines, especially, highly alkylated alkylpyridines, alkyl quinolines, C6 to C24 synthetic tertiary amines, amines derived from natural products such as coconuts, or the like, dialkyl substituted methyl amines, amines derived from the reaction of fatty acids or oils and polyamines, amidoimidazolines of DETA and fatty acids, imidazolines of ethylenediamine, imidazolines of diaminocyclohexane, imidazolines of aminoethylethylenediamine, pyrimidine of propane diamine and alkylated propene diamine, oxyalkylated mono and polyamines sufficient to convert all labile hydrogen atoms in the amines to oxygen containing groups, or the like or mixtures or combinations thereof. Exemplary examples of salts of nitrogen bases, include, without limitation, salts of nitrogen bases derived from a salt, e.g.: C₁ to C₈ monocarboxylic acids such as formic acid, acetic acid, propanoic acid, butanoic acid, pentanoic acid, hexanoic acid, heptanoic acid, octanoic acid, 2-ethylhexanoic acid, or the like; C₂ to C₁₂ dicarboxylic acids, C₂ to C₁₂ unsaturated carboxylic acids and anhydrides, or the like; polyacids such as diglycolic acid, aspartic acid, citric acid, or the like; hydroxy acids such as lactic acid, itaconic acid, or the like; aryl and hydroxy aryl acids; naturally or synthetic amino acids; thioacids such as thioglycolic acid (TGA); free acid forms of phosphoric acid derivatives of glycol, ethoxylates, ethoxylated amine, or the like, and aminosulfonic acids; or mixtures or combinations thereof and an amine, e.g.: high molecular weight fatty acid amines such as cocoamine, tallow amines, or the like; oxyalkylated fatty acid amines; high molecular weight fatty acid polyamines (di, tri, tetra, or higher); oxyalkylated fatty acid polyamines; amino amides such as reaction products of carboxylic acid with polyamines where the equivalents of carboxylic acid is less than the equivalents of reactive amines and oxyalkylated derivatives thereof; fatty acid pyrimidines; monoimidazolines of EDA, DETA or higher ethylene amines, hexamethylene diamine (HMDA), tetramethylenediamine (TMDA), and higher analogs thereof; bisimidazolines, imidazolines of mono and polyorganic acids; oxazolines derived from monoethanol amine and fatty acids or oils, fatty acid ether amines, mono and bis amides of aminoethylpiperazine; GAA and TGA salts of the reaction products of crude tall oil or distilled tall oil with diethylene triamine; GAA and TGA salts of reaction products of dimer acids with mixtures of poly amines such as TMDA, HMDA and 1,2-diaminocyclohexane; TGA salt of imidazoline derived from DETA with tall oil fatty acids or soy bean oil, canola oil, or the like; or mixtures or combinations thereof.

### Other Additives

The fracturing fluids of this invention can also include other additives as well such as scale inhibitors, carbon dioxide control additives, paraffin control additives, oxygen control additives, biocides, gel stabilizers, surfactants, clay control additives, or other additives.

### Scale Control

Suitable additives for Scale Control and useful in the compositions of this invention include, without limitation: Chelating agents, e.g., Na⁺, K⁺ or NH₄⁺ salts of EDTA; Na⁺, K⁺ or NH₄⁺ salts of NTA; Na⁺, K⁺ or NH₄⁺ salts of Erythorbic acid; Na⁺, K⁺ or NH₄⁺ salts of thioglycolic acid (TGA); Na⁺, K⁺ or NH₄⁺ salts of Hydroxy acetic acid; Na⁺, K⁺ or NH₄⁺ salts of Citric acid; Na, K or NH₄⁺ salts of Tartaric acid or other similar salts or mixtures or combinations thereof. Suitable additives that work on threshold effects, sequestrants, include, without limitation: Phosphates, e.g., sodium hexamethylphosphate, linear phosphate salts, salts of polyphosphoric acid, Phosphonates, e.g., nonionic such as HEDP (hydroxythylidene diphosphoric acid), PBTC (phosphoisobutane, tricarboxylic acid), Amino phosphonates of: MEA (monoethanolamine), NH₃, EDA (ethylene diamine), Bishydroxyethylene diamine, Bisaminoethylether, DETA (diethylenetriamine), HMDA (hexamethylene diamine), Hyper homologues and isomers of HMDA, Polyamines of EDA and DETA, Diglycolamine and homologues, or similar polyamines or mixtures or combinations thereof; Phosphate esters, e.g., polyphosphoric acid esters or phosphorus pentoxide (P₂O₅) esters of: alkanol amines such as MEA, DEA, triethanol amine (TEA), Bishydroxyethylethylene diamine; ethoxylated alcohols, glycerin, glycols such as EG (ethylene glycol), propylene glycol, butylene glycol, hexylene glycol, trimethylol propane, pentaeryithrol, neopentyl glycol or the like; Tris & Tetra hydroxy amines; ethoxylated alkyl phenols (limited use due to toxicity problems), Ethoxylated amines such as monoamines such as MDEA and higher amines from 2 to 24 carbons atoms, diamines 2 to 24 carbons carbon atoms, or the like; Polymers, e.g., homopolymers of aspartic acid, soluble homopolymers of acrylic acid, copolymers of acrylic acid and methacrylic acid, terpolymers of acylates, AMPS, etc., hydrolyzed polyacrylamides, poly malic anhydride (PMA); or the like; or mixtures or combinations thereof.

### Carbon Dioxide Neutralization

Suitable additives for use in the fracturing fluids of this invention for CO₂ neutralization and for use in the compositions of this invention include, without limitation, MEA, DEA, isopropylamine, cyclohexylamine, morpholine, diamines, dimethylaminopropylamine (DMAPA), ethylene diamine, methoxy proplyamine (MOPA), dimethylethanol amine, methyldiethanolamine (MDEA) & oligomers, imidazolines of EDA and homologues and higher adducts, imidazolines of aminoethylethanolamine (AEEA), aminoethylpiperazine, aminoethylethanol amine, di-isopropanol amine, DOW AMP-90™, Angus AMP-95, dialkylamines (of methyl, ethyl, isopropyl), mono alkylamines (methyl, ethyl, isopropyl), trialkyl amines (methyl, ethyl, isopropyl), bishydroxyethylethylene diamine (THEED), or the like or mixtures or combinations thereof.

### Paraffin Control

Suitable additives for use in the fracturing fluids of this invention for Paraffin Removal, Dispersion, and/or paraffin Crystal Distribution include, without limitation: Cellosolves available from DOW Chemicals Company; Cellosolve acetates; Ketones; Acetate and Formate salts and esters; surfactants composed of ethoxylated or propoxylated alcohols, alkyl phenols, and/or amines; methylesters such as coconate, laurate, soyate or other naturally occurring methylesters of fatty acids; sulfonated methylesters such as sulfonated coconate, sulfonated laurate, sulfonated soyate or other sulfonated naturally occurring methylesters of fatty acids; low molecular weight quaternary ammonium chlorides of coconut oils, soy oils or C₁₀ to C₂₄ amines or monohalogenated alkyl and aryl chlorides; quanternary ammonium salts composed of disubstituted (e.g., dicoco, etc.) and lower molecular weight halogenated alkyl and/or aryl chlorides; gemini quaternary salts of dialkyl (methyl, ethyl, propyl, mixed, etc.) tertiary amines and dihalogenated ethanes, propanes, etc. or dihalogenated ethers such as dichloroethyl ether (DCEE), or the like; gemini quaternary salts of alkyl amines or amidopropyl amines, such as cocoamidopropyldimethyl, bis quaternary ammonium salts of DCEE; or mixtures or combinations thereof. Suitable alcohols used in preparation of the surfactants include, without limitation, linear or branched alcohols, specially mixtures of alcohols reacted with ethylene oxide, propylene oxide or higher alkyleneoxide, where the resulting surfactants have a range of HLBs. Suitable alkylphenols used in preparation of the surfactants include, without limitation, nonylphenol, decylphenol, dodecylphenol or other alkylphenols where the alkyl group has between about 4 and about 30 carbon atoms. Suitable amines used in preparation of the surfactants include, without limitation, ethylene diamine (EDA), diethylenetriamine (DETA), or other polyamines. Exemplary examples include Quadrols, Tetrols, Pentrols available from BASF. Suitable alkanolamines include, without limitation, monoethanolamine (MEA), diethanolamine (DEA), reactions products of MEA and/or DEA with coconut oils and acids.

### Oxygen Control

The introduction of fracturing fluids downhole often is accompanied by an increase in the oxygen content of downhole fluids due to oxygen dissolved in the introduced water. Thus, the materials introduced downhole must work in oxygen environments or must work sufficiently well until the oxygen content has been depleted by natural reactions. For a system that cannot tolerate oxygen, then oxygen must be removed or controlled in any material introduced downhole. The problem is exacerbated during the winter when the injected materials include winterizers such as water, alcohols, glycols, Cellosolves, formates, acetates, or the like and because oxygen solubility is higher to a range of about 14-15 ppm in very cold water. Oxygen can also increase corrosion and scaling. In CCT (capillary coiled tubing) applications using dilute solutions, the injected solutions result in injecting an oxidizing environment (O₂) into a reducing environment (CO₂, H₂S, organic acids, etc.).

Options for controlling oxygen content includes: (1) de-aeration of the fluid prior to downhole injection, (2) addition of normal sulfides to produce sulfur oxides, but such sulfur oxides can accelerate acid attack on metal surfaces, (3) addition of erythorbates, ascorbates, diethylhydroxyamine or other oxygen reactive compounds that are added to the fluid prior to downhole injection; and (4) addition of corrosion inhibitors or metal passivation agents such as potassium (alkali) salts of esters of glycols, polyhydric alcohol ethyloxylates or other similar corrosion inhibitors. Oxygen and corrosion inhibiting agents include mixtures of tetramethylene diamines, hexamethylene diamines, 1,2-diaminecyclohexane, amine heads, or reaction products of such amines with partial molar equivalents of aldehydes. Other oxygen control agents include salicylic and benzoic amides of polyamines, used especially in alkaline conditions, short chain acetylene diols or similar compounds, phosphate esters, borate glycerols, urea and thiourea salts of bisoxalidines or other compound that either absorb oxygen, react with oxygen or otherwise reduce or eliminate oxygen.

### Salt Inhibitors

Suitable salt inhibitors for use in the fluids of this invention include, without limitation, Na Minus -Nitrilotriacetamide available from Clearwater International, LLC of Houston, Tex.

### Experiments of the Invention

The experiments set forth herein are designed to test the use of synthetic polymers in fracture fluid systems that is comparable to a simplified Dynafrac system at 65° C.-149° C. (150° F.-300° F.) to determine (a) viscosity profiles in CC120 (choline chloride), 2 wt. % KCl and seawater systems, (b) hydration rates to meet 90% of max viscosity, (c) effects of calcium and magnesium ions, (d) gel stability versus temperature, (e) breaking profiles of the polymers by various breakers, (f) proppant transport capabilities, (g) compatible of these systems with additives, and (h) return permeability properties.

The polymers used in the experiments set forth here are listed in Table I.

TABLE I
Polymer Designations and Identities

| Polymer Designation | Polymer |
|---|---|
| P1 | CARBOPOL ® EZ-4A |
| P2 | CARBOMER 940 |
| P3 | CARBOPOL ® EZ-2 |
| P4 | CARBOPOL ® EZ-3 |
| P5 | CARBOMER 980 |

### Laboratory Procedures

Lab Mixing/Hydration Procedure Using Waring Blender

Pour 200 mL 2% KCl (or synthetic seawater) into the glass blender. Add the required concentration of synthetic polymer into the blender. Add the 50%-Sodium hydroxide in 0.1 mL increment level into the blender until it reaches a neutral pH, and becomes viscous. Add the required concentration of additive(s) into the blender if running additive(s) compatibility test. Add the required concentration of proppant into the blender if running proppant suspension test. Allow 5 minutes for the whole mixing process or if running hydration test then stop mixing at required times. Stop the blender and measure the viscosity at the required conditions.

Gel Stability/Break Procedure

The Brookfield Model PVS Rheometer is designed to test fluid samples by simulating process conditions in a bench top environment (sample boil-off problems are eliminated). The PVS Rheometer measures with a coaxial cylinder geometry and delivers excellent accuracy and outstanding sensitivity. The rheometer responds to time and temperature changes in viscosity, mechanically transmitting a rotational torque signal from the pressure containment area without friction.

Brookfield PVS Rheometer

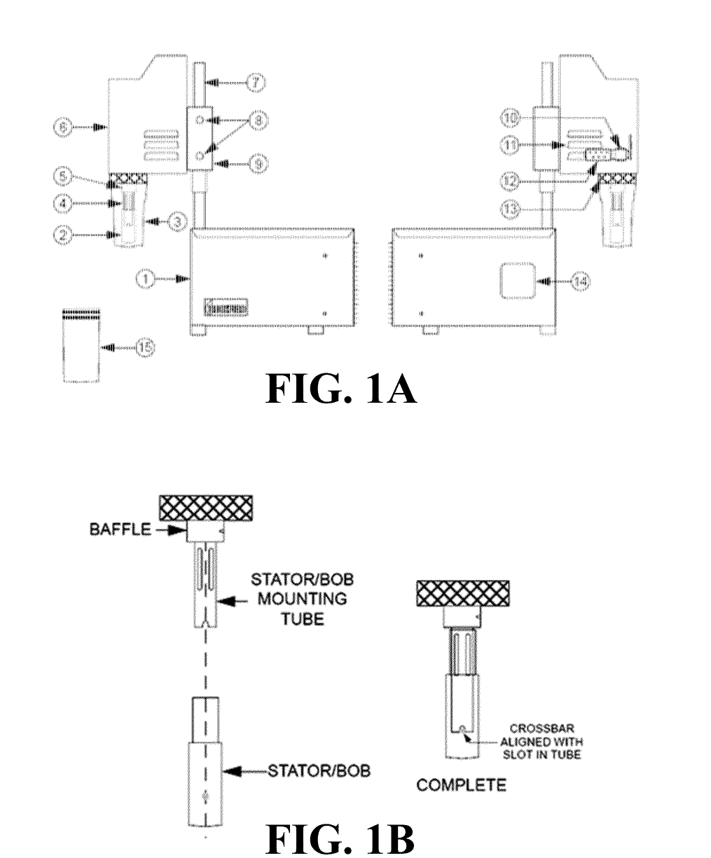

Referring now to FIGS. 1A&B, a typical PVS rheometer including a power base 1, a stator/bob 2, a sample cup 3, a torsion element/mounting tube assembly 4, a baffle 5, a rheometer head cover 6, an upright rod 7, a PVS rheometer head clamping screw 8, a rheometer head clamp 9, a three-way valve 10, a louver 11, a safety relief valve 12, a knurled ring 13, a cable connector panel 14, and a torsion element guar 15.

### Results & Discussion

Hydration Rate

Hydration rate is a key parameter to be measured for hydratable polymer systems to determine how much residence time is required before the systems can be pumped down hole. Once the polymer system is dispersed in a base fluid such as a base fluid including 0.2 wt. % to 0.6 wt. % CC120 (choline chloride) in a 2 wt. % KCl (potassium chloride) solution or in seawater, the polymer system's ability to untangle and absorb water dictates its hydration rate. The hydration rate may be controlled by mixing times/peed as well as by the addition of pH adjusters such as hexamethylenediamine (HMD), hexamethyleneimine (HMI), or a 50 wt. % sodium hydroxide solution.

The hydration rates for each synthetic polymer system tested at different concentrations with addition of a pH adjuster in different base fluids are presented below. The present synthetic polymer systems were designed to achieve sufficient viscosity to suspend proppants at the fastest hydration rate possible. In certain embodiments, the sufficient viscosity is about 350 cP (centipoise), which means that the synthetic polymer systems behave similar to traditional natural guar systems.

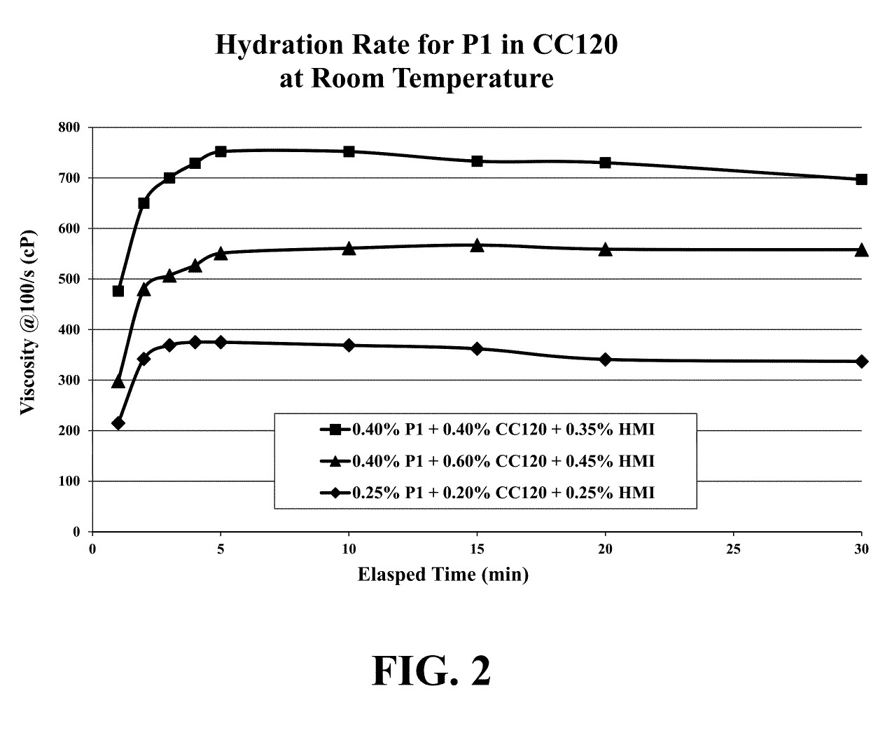

As shown in FIG. 2, a system including 0.25 wt. % of P1, 0.2 wt. % CC120, and 0.25 vol. % of HMI afforded a viscosity of 350 cP or above, a viscosity sufficient to suspend proppants. With about 3 minutes of mixing, a sufficient mixing time, the P1 polymer within the fluid had already fully hydrated, which suggests the hydration time (or a hydration unit) may be shortened or eliminated in the field operations. In fluid that contain higher concentrations of CC120, 0.4 wt. % and 0.6 wt. %, a higher amount of the P1 polymer was needed to attain a sufficient viscosity. Even though, as shown in FIG. 2, the mixing time was between 3 and 5 minutes and was sufficient for reaching a sufficient proppant suspension viscosity.

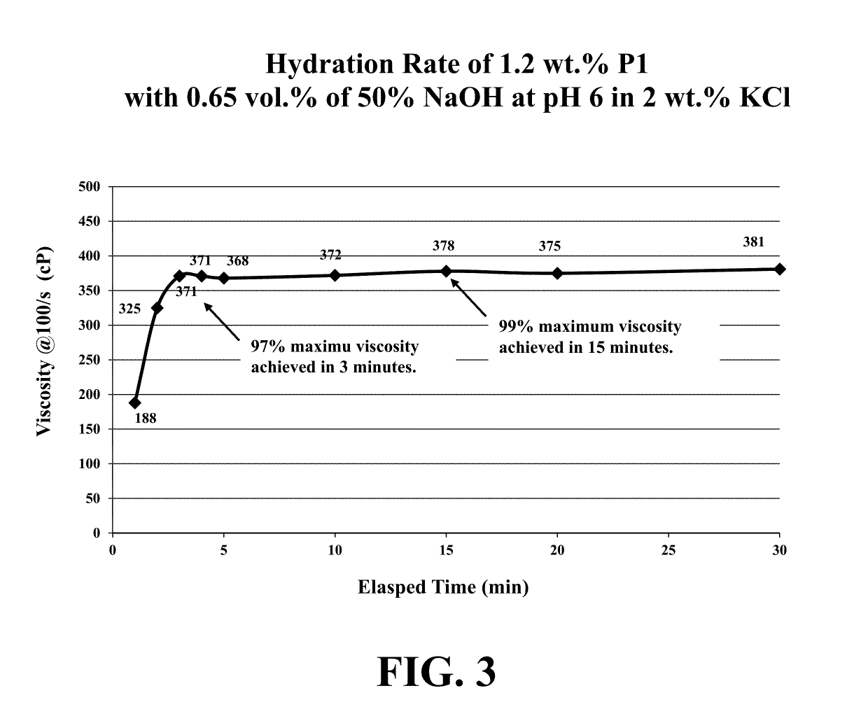

As shown in FIG. 3, a 1.2 wt. % P1 system reached 97% of its maximum viscosity in 3 minutes and 99% of its maximum viscosity in 15 minutes with mixing at room temperature (i.e., a temperature between 20° C. and 25° C.). The pH of the system was adjusted to neutral (i.e., a pH between 6 and 7) using a 50 wt. % sodium hydroxide (NaOH) solution.

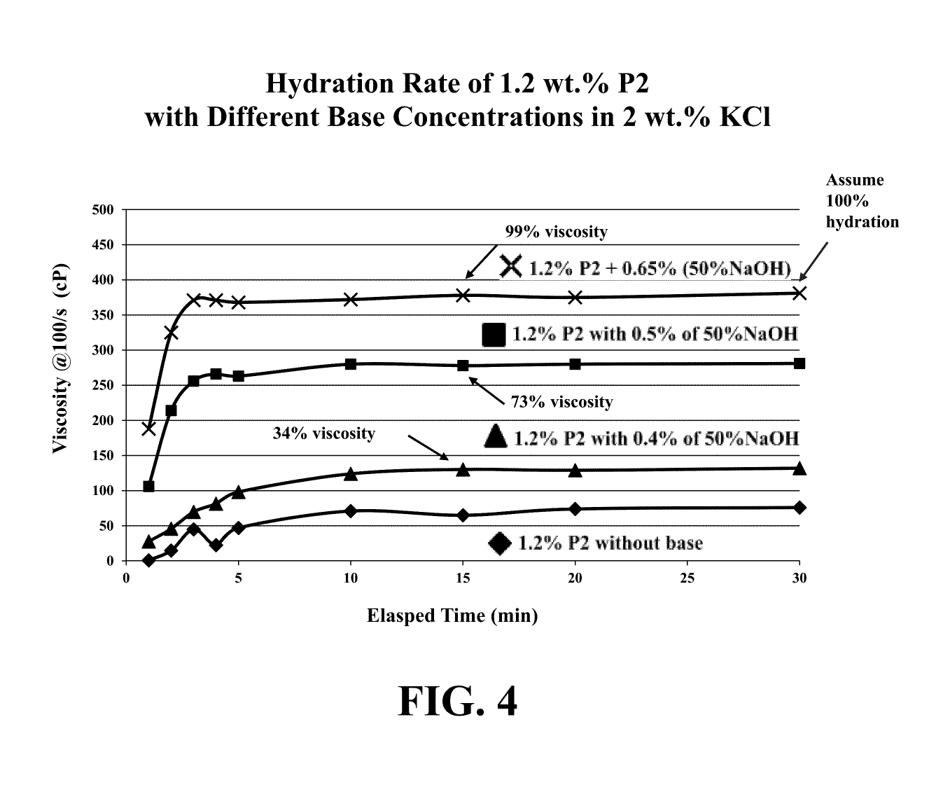

As shown in FIG. 4, a 1.2 wt. % P2 system was tested in 2% Kcl at different concentrations of added base—a 50 wt. % sodium hydroxide (NaOH) solution. The data showed that low concentrations of added base lowered the P2 system viscosity. The ability to adjust viscosity of the P2 system by adjusting the amount of base added may be beneficial in field operations lowering the risk of plugging of hoses in the low and high pressure lines as opposed to adding a full dose of base—a 50 wt. % sodium hydroxide solution to the P2 system at one time.

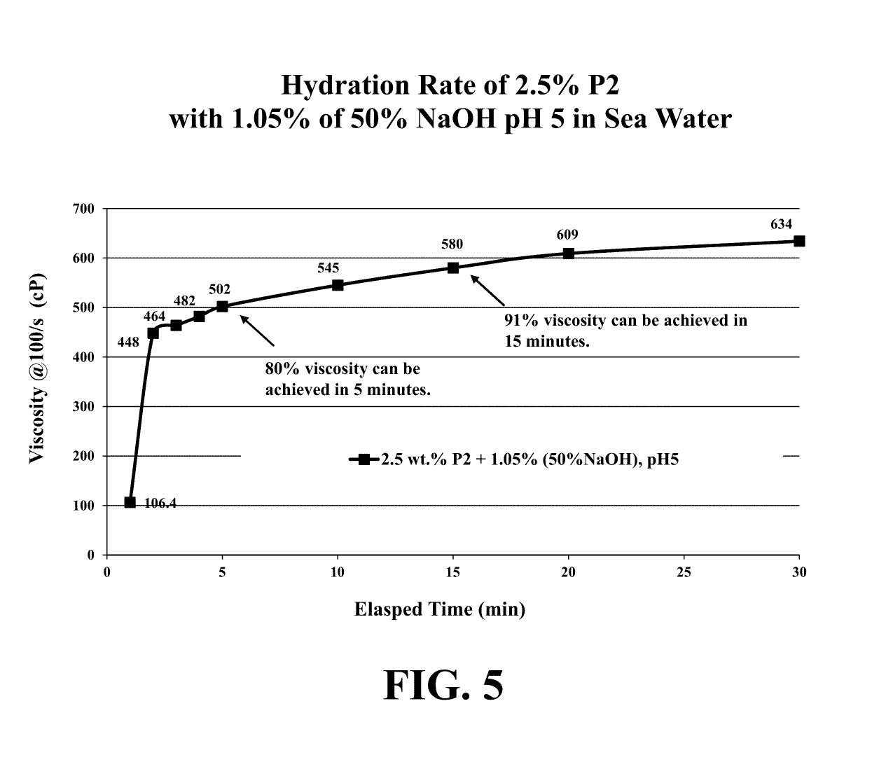

As shown in FIG. 5, a 2.5 wt. % P2 system was tested in seawater. The P2 system reached 80% of its maximum viscosity in 5 minutes and 91% of its maximum viscosity in 15 minutes with mixing at room temperature (i.e., 20° C.-25° C.). The pH of the system was adjusted to a pH between 5 and 6 using 1.05 vol. % of a 50 wt. % sodium hydroxide solution.

In traditional natural polymer systems such as guar systems, the hydration time required to reach maximum viscosity in approximately half an hour. Thus, the hydration rates for the synthetic polymer systems P1 and P2 are much faster requiring only between 3 and 5 minutes in 2% KCl and seawater.

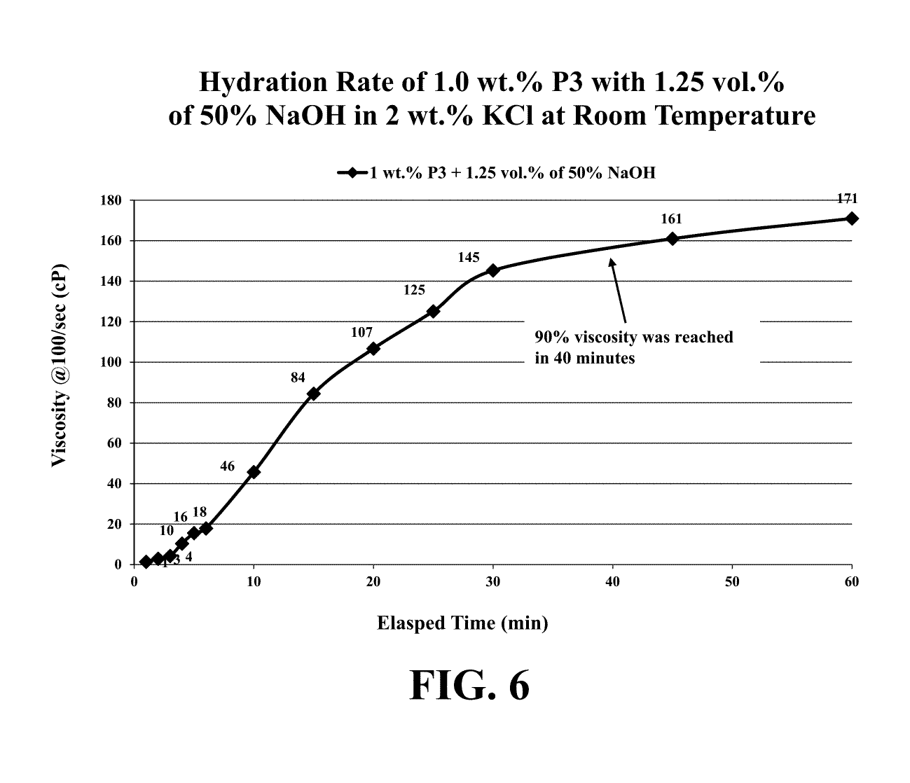

As shown in FIG. 6, the performance of a 1.0 wt. % P3 system was tested in 2 wt. % KCl. The P3 system reached 90% of its maximum viscosity in about 45 minutes. The pH of the system was adjusted to a pH between 5 and 6 using 1.25 vol. % of a 50 wt. % sodium hydroxide solution.

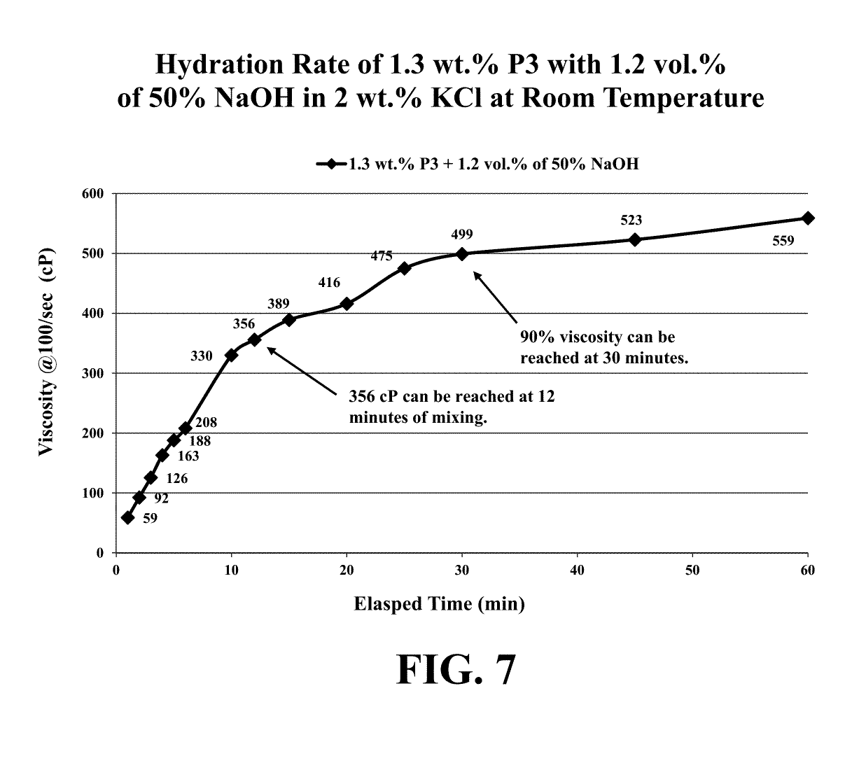

As shown in FIG. 7, the performance of a 1.3 wt. % P3 system was tested in 2 wt. % KCl. The P3 system reached 90% of its maximum viscosity in about 45 minutes. The pH of the system was adjusted to a pH between 5 and 6 using a 50 wt. % sodium hydroxide solution.

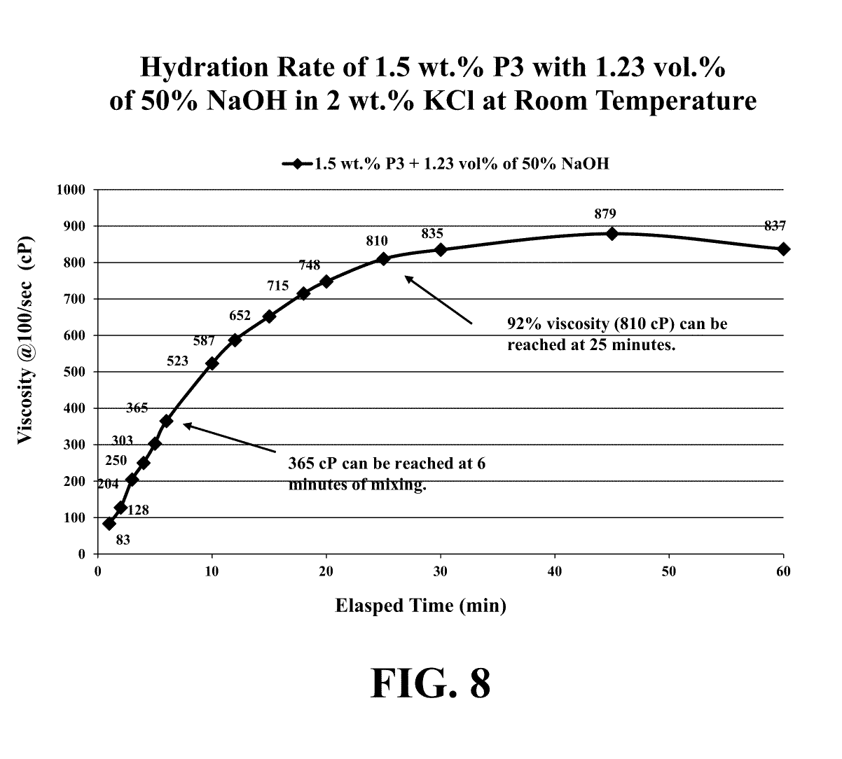

As shown in FIG. 8, the performance of a 1.5 wt. % P3 system was tested in 2 wt. % KCl. The P3 system reached 90% of its maximum viscosity in about 45 minutes. The pH of the system was adjusted to a pH between 5 and 6 using a 50 wt. % sodium hydroxide solution.

Thus, by controlling the amount of each synthetic polymers used in a system and the type of exact synthetic polymers used in a system, the hydrate rate may be adjusted to suit any desired downhole environment or any desired viscosity profile for a given fracturing operation.

### Effect of pH

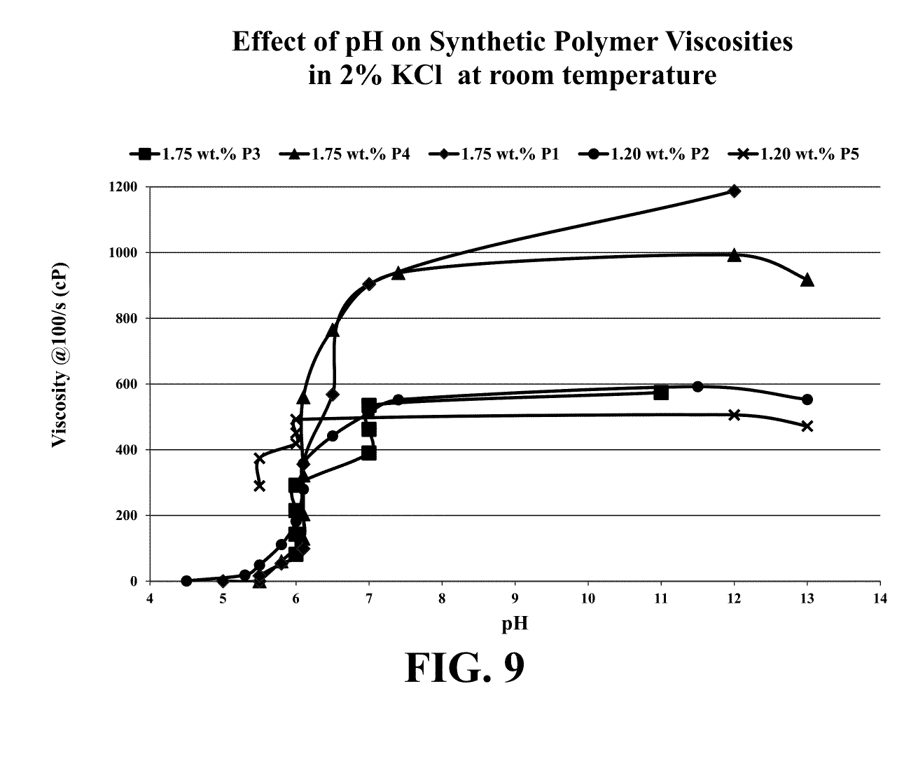

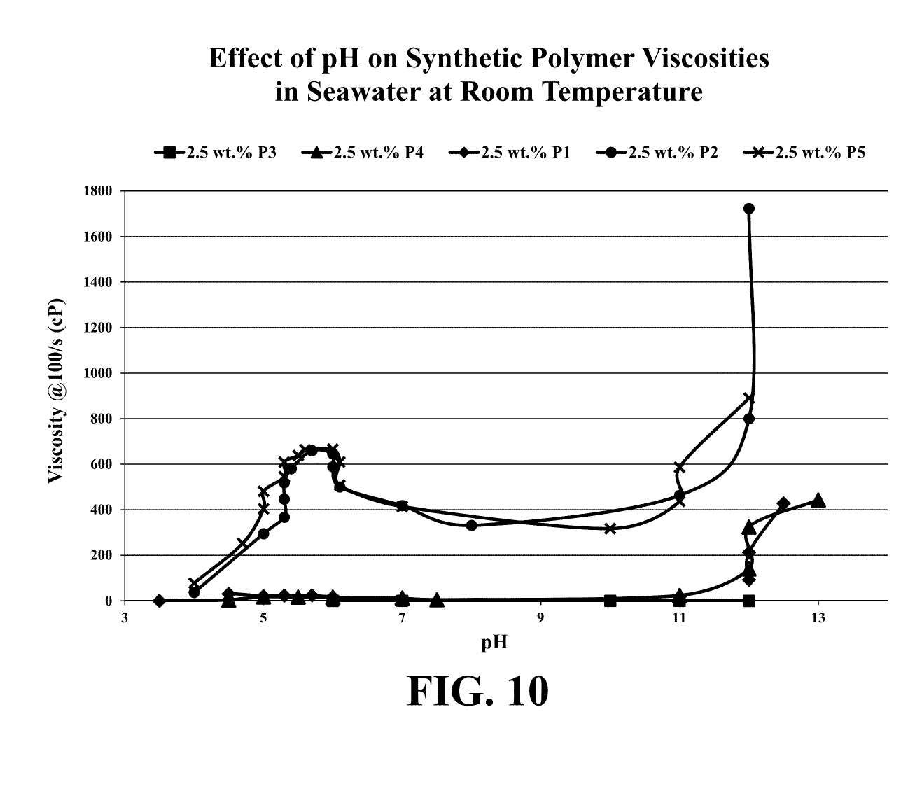

The effect of pH was also studied before breakers testing in order to determine the optimal pH range for formulating the fluid systems of this invention. The pH was varied by the addition of different amounts of a 50 wt. % sodium hydroxide solution, viscosities measured at 100 /sec shear were observed at different pH values at room temperature. FIG. 9 shows the effect of pH on P1-P5 systems at room temperature in a 2 wt. % KCl base fluid. FIG. 10 shows the effect of pH on P1-P5 systems at room temperature a seawater base fluid. The data shows usable pH ranges for the five synthetic polymers system P1-P5 in both 2 wt. KCl and seawater.

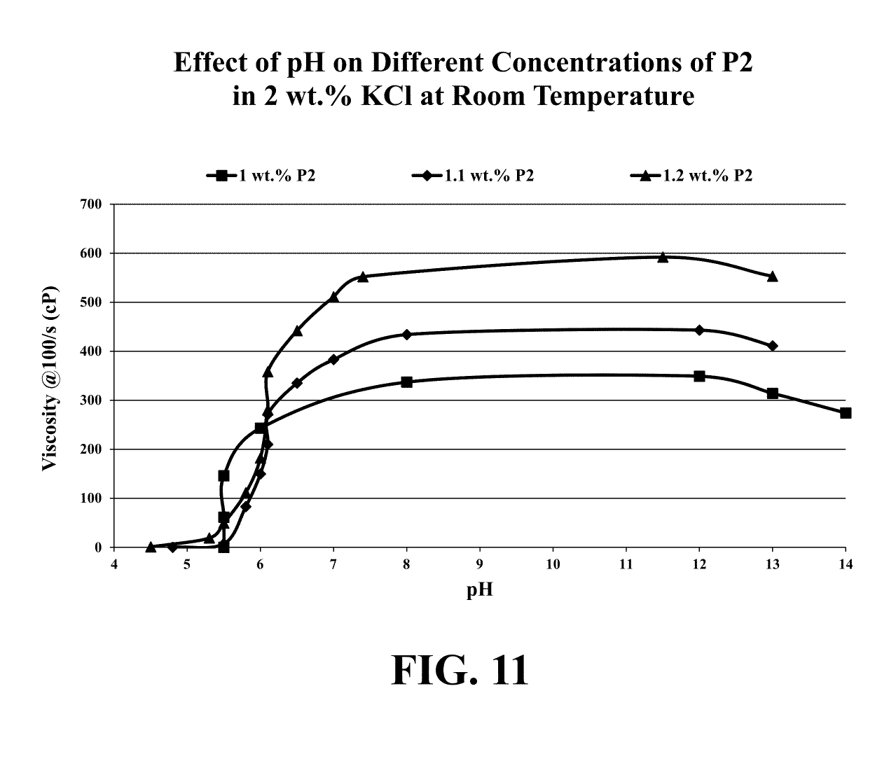

As shown in FIG. 11, the effect of pH on a P2 system at room temperature by neutralizing the P2 system with 50 wt. % sodium hydroxide solution in a 2 wt. % KCl base fluid. The data showed that at a pH of about 5.5, the P2 fluid system starts hydrating quickly. From pH 6 to 7.5, the P2 fluid system is still hydrating and higher viscosities were also obtained. When a small amount of a 50 wt. % sodium hydroxide solution was added to the P2 fluid system, pH shoots up usually from 7 to 12 quickly, while viscosity increases more slowly. As more and more sodium hydroxide solution was added to the system, pH increases, while fluid viscosities started to drop. This suggested that the best hydration range for this synthetic polymer fluid systems of this invention is around at a pH range between 6 and 7.5. Adding too much pH adjuster does not help in increasing viscosity drastically, but the fluids become corrosive.

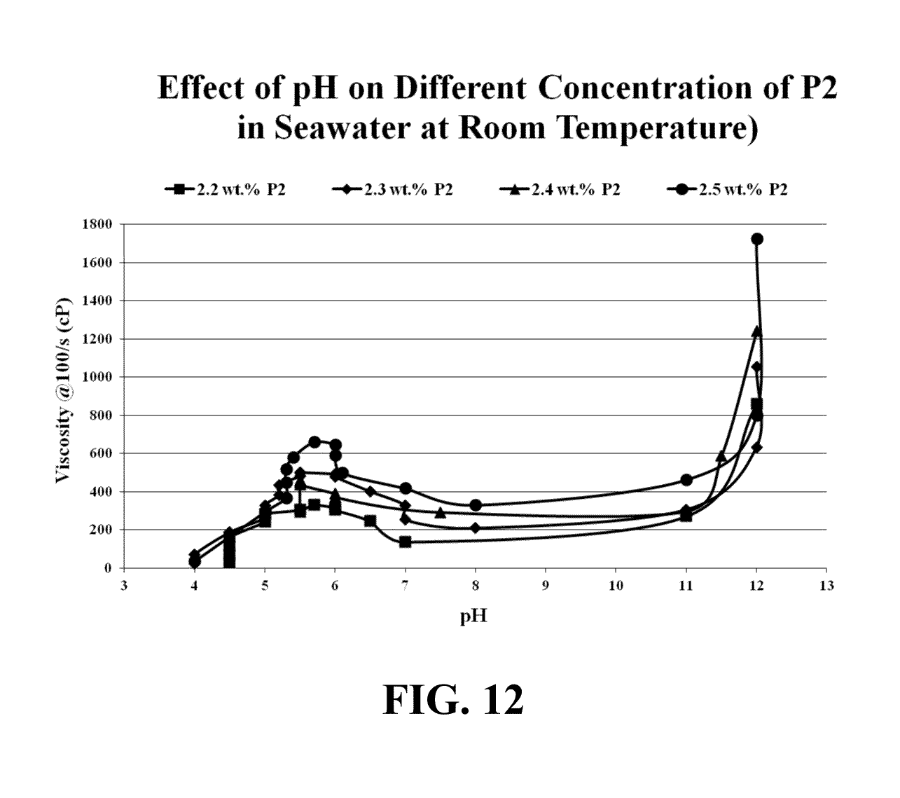

FIG. 12 shows the effect of pH on P2 at room temperature by neutralizing with a 50 wt. % sodium hydroxide solution in seawater. In the seawater, the data showed that viscosity peaks at a pH between about 5 and about 6, and at pH 12 and above. Even though at pH above 12 the fluids gave very high viscosities, a very large amount of pH adjuster was needed to be added into the system, which makes the systems very corrosive, and possibly harder to break.

In fluids including 0.6 wt. % CC120 base fluids, all tested synthetic polymer fluid systems appear high in viscosity at a pH range between 6 and 11. In fluids including 2 wt. % KCl base fluids, all tested synthetic polymer fluid systems were observed that at around pH 6, viscosities shoot up from 100 cP.

### Gel Stability and Temperature Effect

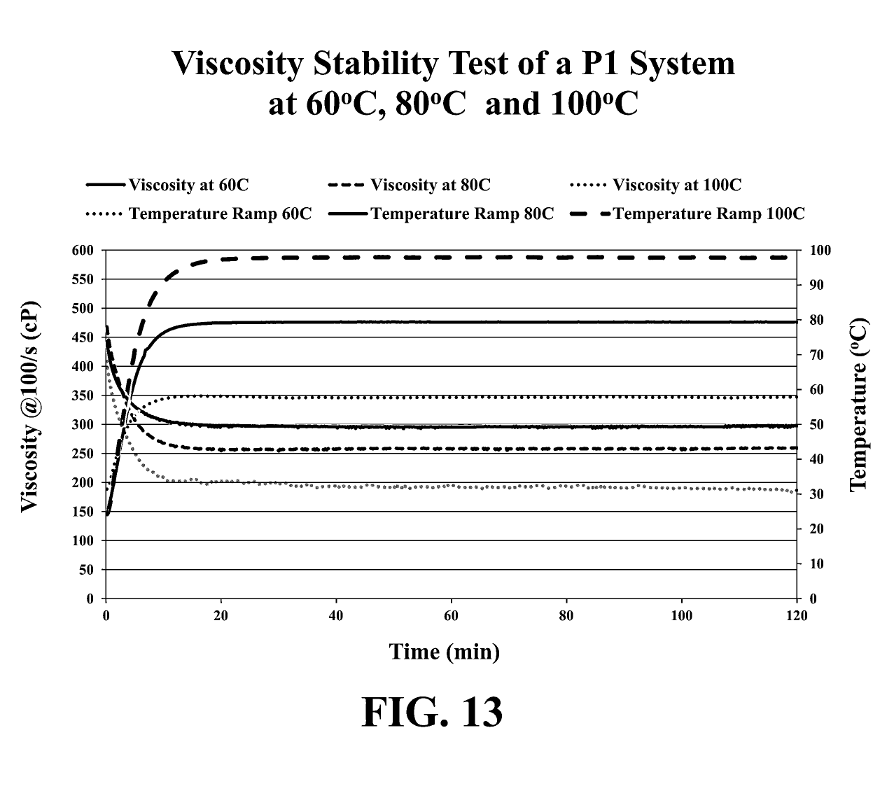

P1 fluid system performance was tested at various temperatures to ascertain how much thermal thinning would occur. A P1 system including 0.40 wt. % P1, 0.60% CC120, and 0.45 vol. % HMI was used for testing gel stability and break profiles. As shown in FIG. 13, gel viscosity stability, without any breakers, was tested at 60° C., 80° C. and 100° C. on a Brookfield PVS instrument. The data showed that at 60° C., the viscosity of the P1 fluid system stabilized at 300 cP within a 2-hour period. The data showed that at 80° C., the viscosity of the P1 fluid system stabilized at around 260 cP within a 2-hour period. The data showed that at 100° C., the viscosity of the P1 fluid system stabilized at around 190 cP within a 2-hour period. The data demonstrated the temperature viscosity dependent of P1 systems.

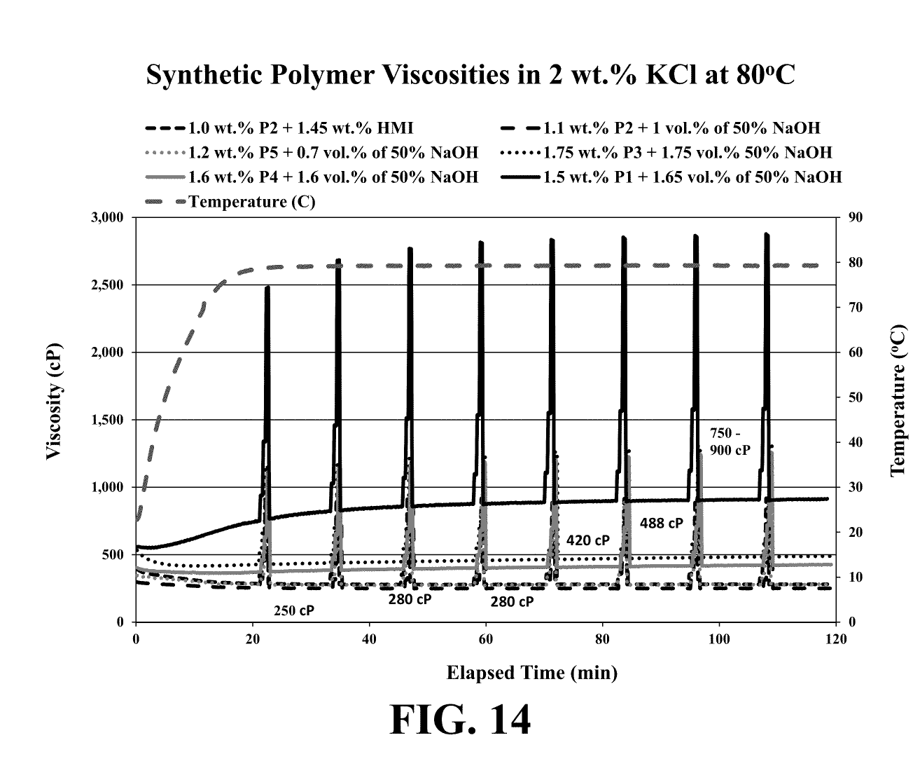

Gel stability tests were run for a 2 hour period to check if any thermal thinning occurred in the P1-P5 gelled synthetic polymer fluid systems of this invention. As shown in FIG. 14, the gel stability of P1-P5 at various concentration are shown at 80° C. The data showed that all polymer systems had stable viscosities with minimal thinning at 80° C.

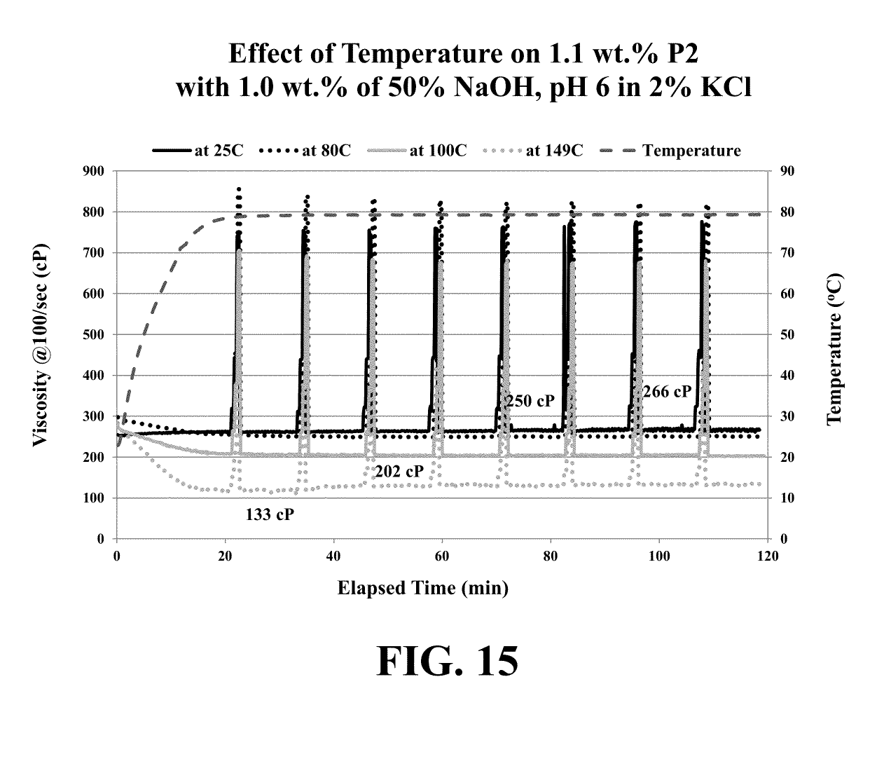

As shown in FIG. 15, the temperature effect on viscosity of a fluid system including 1.1 wt. % P2 and 0.65 vol % of 50% sodium hydroxide in 2 wt. % KCl base fluid at a pH of about 6 showed that the system had a stable viscosity for the first 2 hours at temperatures between 25° C. and 149° C. The viscosities stabilized at around 266 cP at 25° C.; 250 cP at 80° C.; 202 cP at 100° C.; and 133 cP at 149° C., respectively.

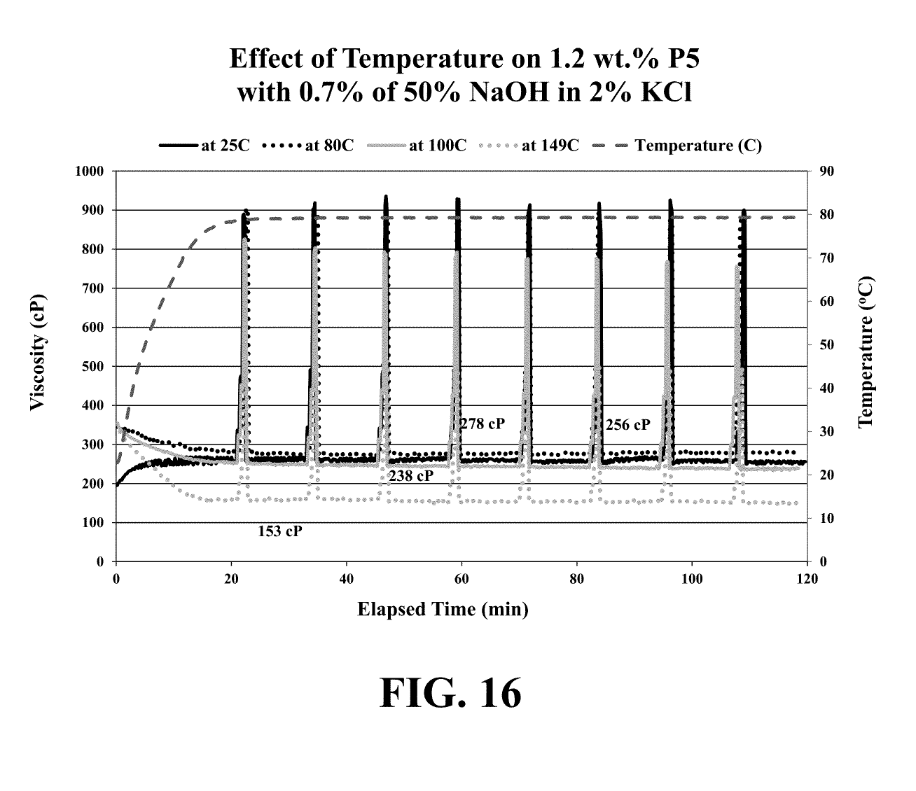

As shown in FIG. 16, the temperature effect on viscosity of a fluid system including 1.2 wt. % P5 and 0.7 vol % of 50% sodium hydroxide in 2 wt. % KCl base fluid showed that the system had a stable viscosity for the first 2 hours at temperatures between 25° C. and 149° C. The viscosities stabilized at around 256 cp at 25° C.; 278 cP at 80° C.; 238 cP at 100° C.; and 153 cP at 149° C., respectively.

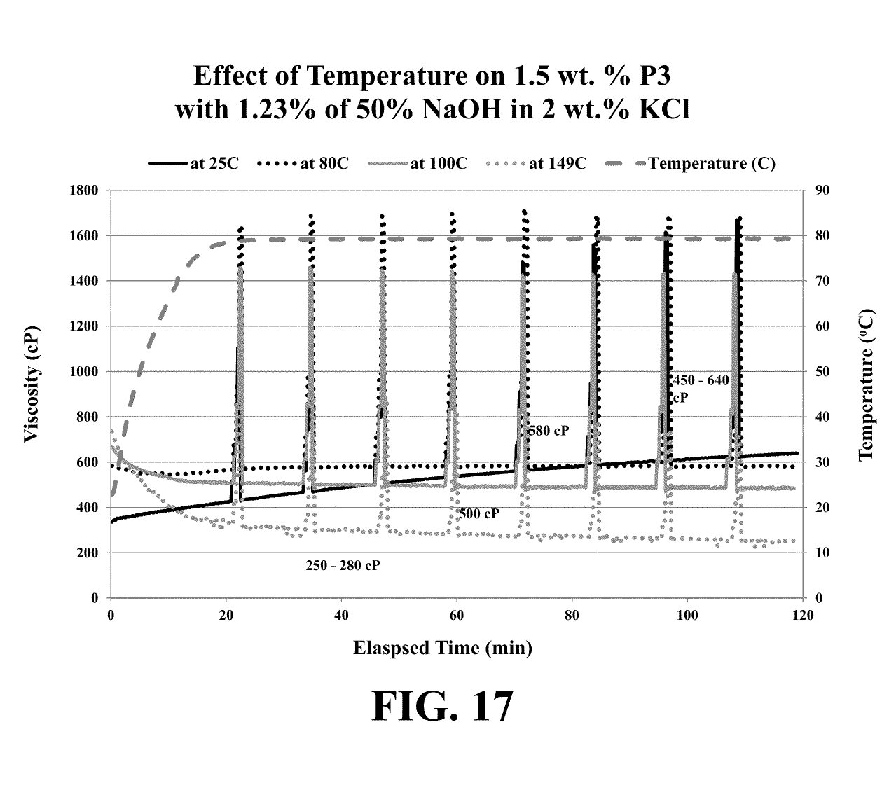

As shown in FIG. 17, the temperature effect on viscosity of a fluid system including 1.5 wt. % P3 and 1.23 vol % of 50% sodium hydroxide in 2 wt. % KCl base fluid showed that the system had a stable viscosity for the first 2 hours at temperatures between 80° C. and 149° C., but the viscosity of the system at 25° C. rises from about 380 cp to about 640 cP over the 2 hour test period. The viscosities stabilized at around 580 cP at 80° C.; 500 cP at 100° C.; and between 205-280 cP at 149° C., respectively.

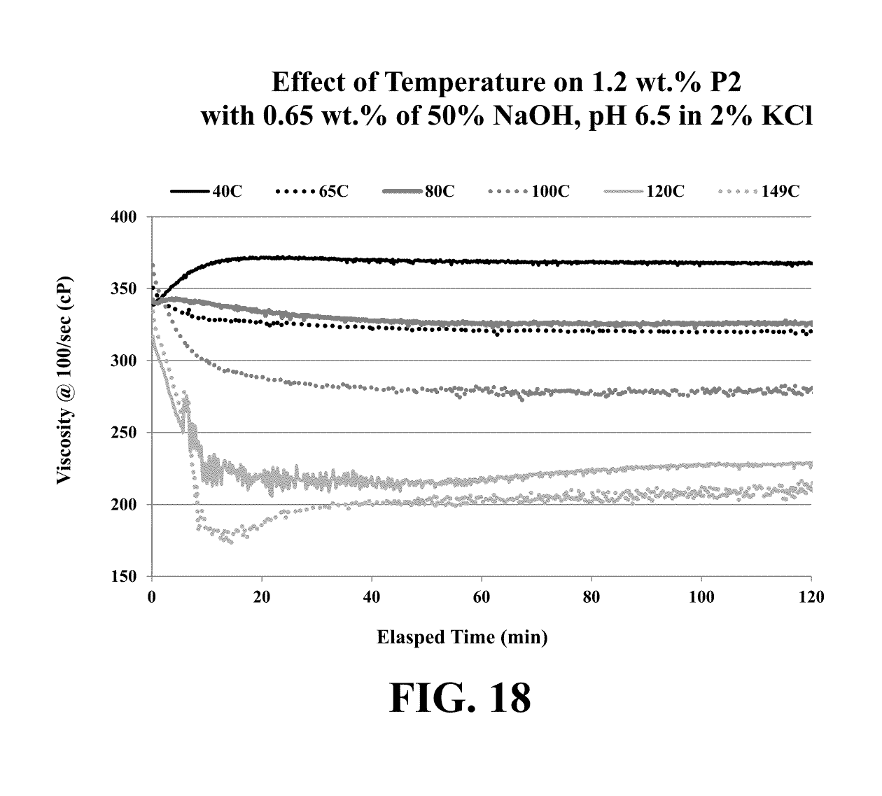

As shown in FIG. 18, the temperature effect on a fluid system including 1.2 wt. % P2 and 0.65 vol % of 50% sodium hydroxide in 2% KCl base fluid at a pH of about 6.5 showed that the system had a stable viscosity within the same temperature at least for the first 2 hours, and temperature varied between 40° C. and 149° C. Fluid stabilized at around 368 cP at 40° C.; 341 cP at 65° C.; 325 cP at 85° C.; 278 cP at 100° C.; 228 cP at 120° C.; and 210 cP at 149° C., respectively.

Further breakers test were based on this P2 system in the 2% KCl system, which requires lesser amounts of P2 to achieve a viscosity of 350 cP for proppant suspension requirements.

### Breaker Profiles

A number of breakers were evaluated both conventional and unconventional in the sense that we know this system is not salt tolerant and is pH sensitive. Breakers were tested at various concentrations and temperatures with the Brookfield PVS.

The following breakers set forth in Table II were tested on the Brookfield PVS.

TABLE II
Effective Breaker Designations and Identities

| | |
|---|---|
| Breaker Designation | Breaker |

Effective Breakers

| | |
|---|---|
| B1 | DRB-HT |
| B2 | ENCAP KP-LT |
| B3 | WBK-134 |
| B8→B4 | PROCAP CA |
| B9→B5 | PROCAP CA-HT |
| B10→B6 | WBK-139 |
| B15→B7 | WBK 133 |
| B17→B8 | DRB-HT |

The effective breakers are capable of breaking the synthetic hydratable polymer fluid systems at certain concentrations and temperatures. In certain embodiment, the effective breakers include B1 at a temperature between 80° C. and 100° C.; B3 at a temperature of 100° C.; and B2 at a temperature of 100° C. Breaking performance of many of theses breakers are shown in more detail herein.

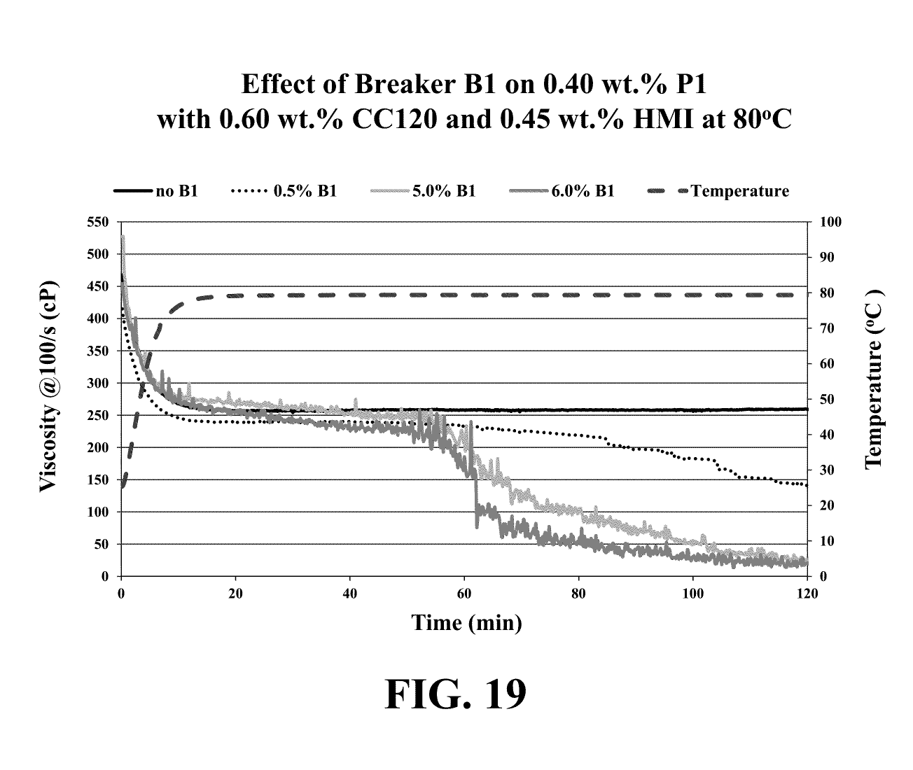

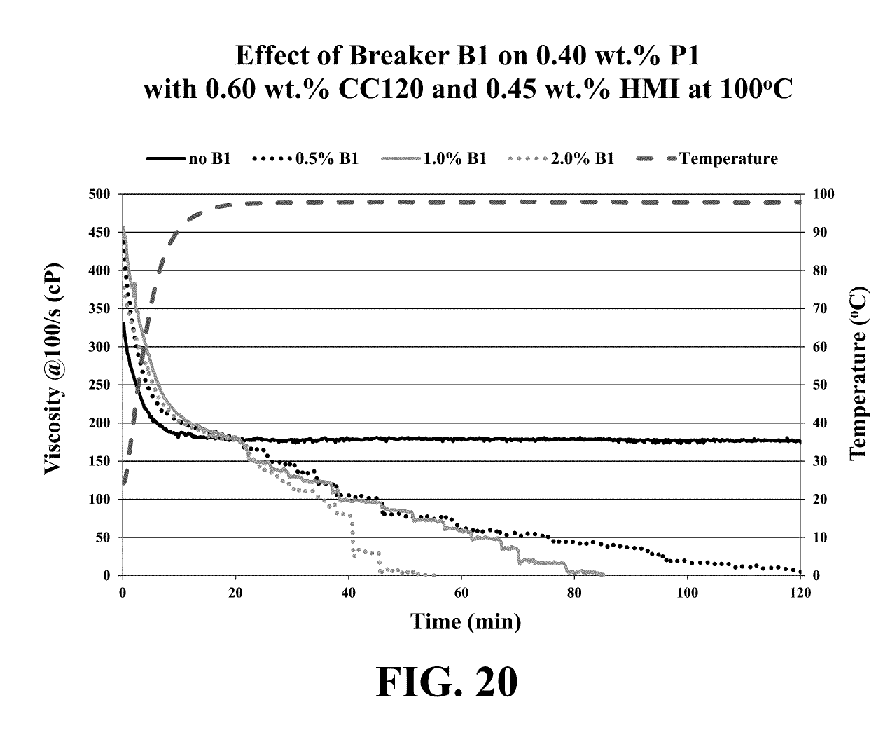

B1 is a resin coated or resin encapsulated ammonium persulfate breaker, which breaks the synthetic polymer fluid systems of this invention due to the ionic nature of the systems and the ionic nature of ammonium persulfate, but does not break the gel via oxidative activity. FIGS. 19&20 show the breaking profiles for B1 on a P1 system of this invention at different temperatures.

B1 worked exceptionally well as a breaker at 100° C., where the resin coating breaks down slowly to release the ammonium persulfate. For lower temperatures, higher concentrations were required and at 60° C., B1 is not effective as the temperature is not high enough to break down the coating and releasing the ammonium persulfate.

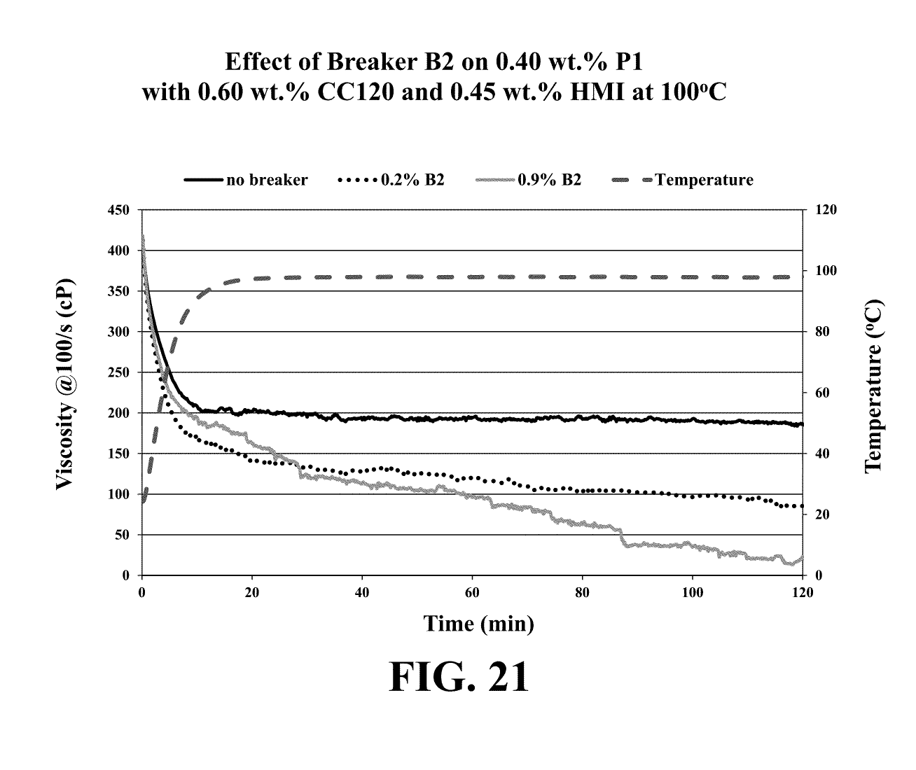

B2 is another resin encapsulated breaker containing potassium persulfate, where the resin coat breaks down at a lower temperature. FIG. 21 shows the breaking profiles for B2 of a P1 system of this invention at 100° C.

The test results for B2 showed that B2 is not much different from B1 in terms of how quickly the gel breaks and a similar concentration of B2 yielded a viscosity compared to the B1 breaking profile.

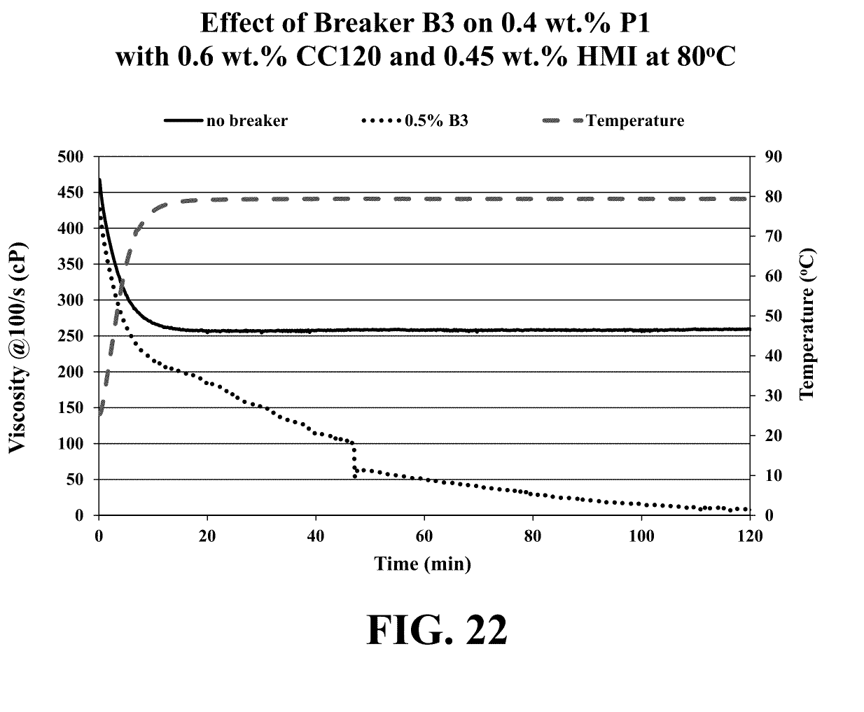

B3 is an encapsulated oxidizing breaker for use as a delayed release breaker that has been used to break guar based fracturing fluids. B3 is a low temperature version of B1. FIG. 22 shows the breaking profiles for B3 on a P1 system of this invention at 80° C.

If lower breaking temperatures are required, B3 may be used for breaking the gelled systems of this invention. The results demonstrated that encapsulated breakers are effective in breaking the synthetic polymer based fluids of this invention. However, due to the unique nature of the synthetic polymer based systems of this invention, encapsulated breaker concentrations, mixtures and breakdown characteristics may be controlled to provide a desired breaking profile for each synthetic polymer based fluid system of this invention.

At 65° C., some of the encapsulated breakers the outercoating of resins or lipids start degrading, therefore their encapsulated chemicals start breaking the fluids according to their mechanisms. B3 is an encapsulated ammonium persulfate with cured acrylic resin and crystalline-quartz silica coating and B8 is an encapsulated citric acid with cured resin coating. B7 is an encapsulated ammonium persulfate.

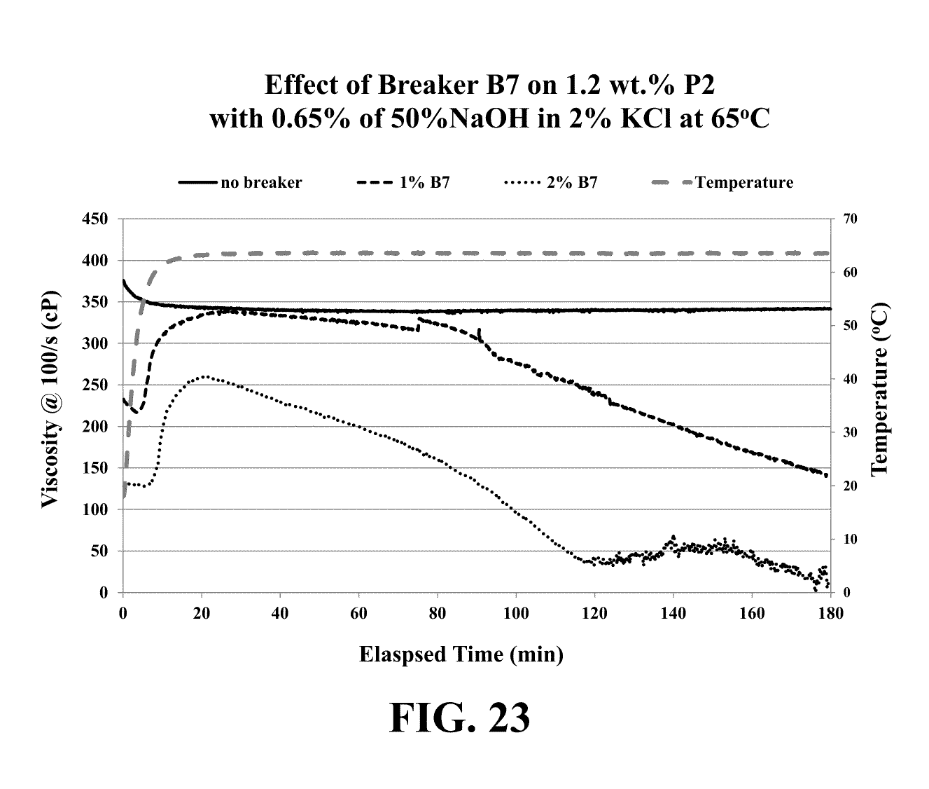

As shown in FIG. 23, 2 wt. % B7 produced a nice breaking profile for a P2 system with a 60 minutes time delay for proppant suspension and was able to break this system in 3 hours.

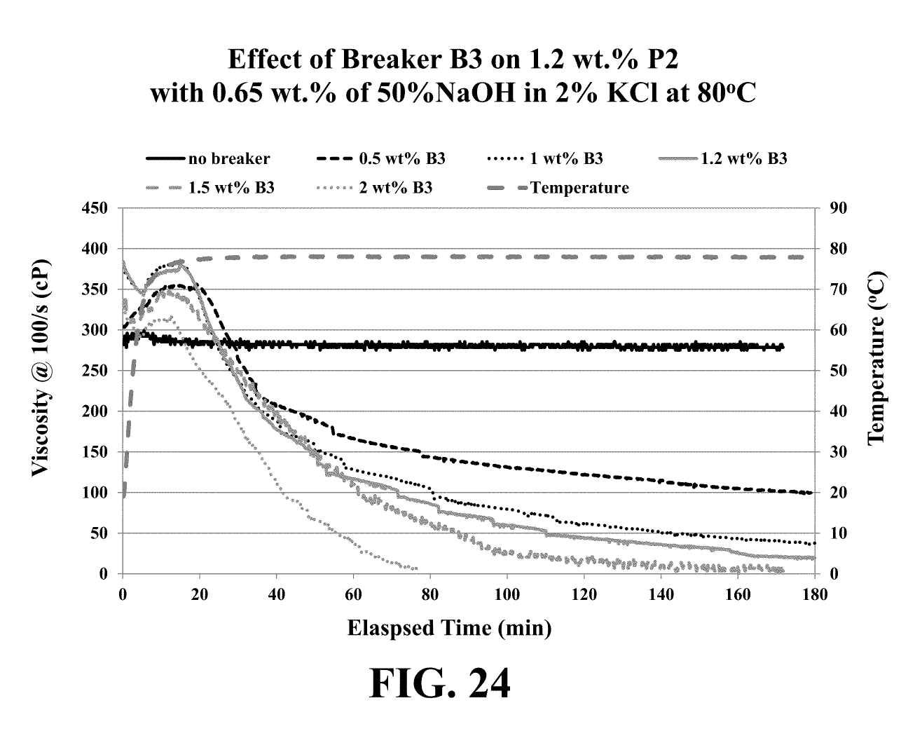

As shown in FIG. 24, different concentrations of B3 were able to hold a P2 system at a fluid viscosity high enough (>200 cP) to suspend proppants for about 40-50 minutes; and then start breaking down the P2 system to viscosity of 10 cP. B3 can hold viscosity >200 cP for about 43 minutes at 0.5 wt. % and for about 30 minutes at 2 wt. % of B3 at 80° C.

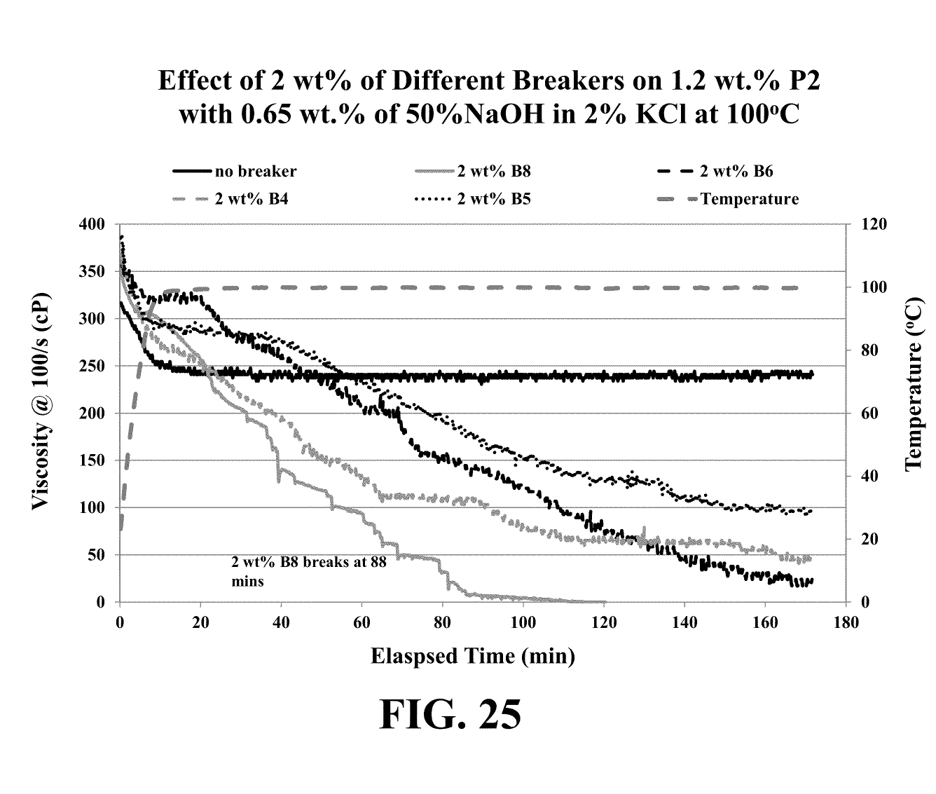

As shown in FIG. 25, 2 wt. % of B4, B5, B6, and B8 breaking profiles are shown in a 1.2 wt. % P2 system over a 175 minute period. Breaker B8 is more effective that breakers B4, B5 and B6, with B5 having a longer breaking profile than B6, which has a longer breaker profile than B4.

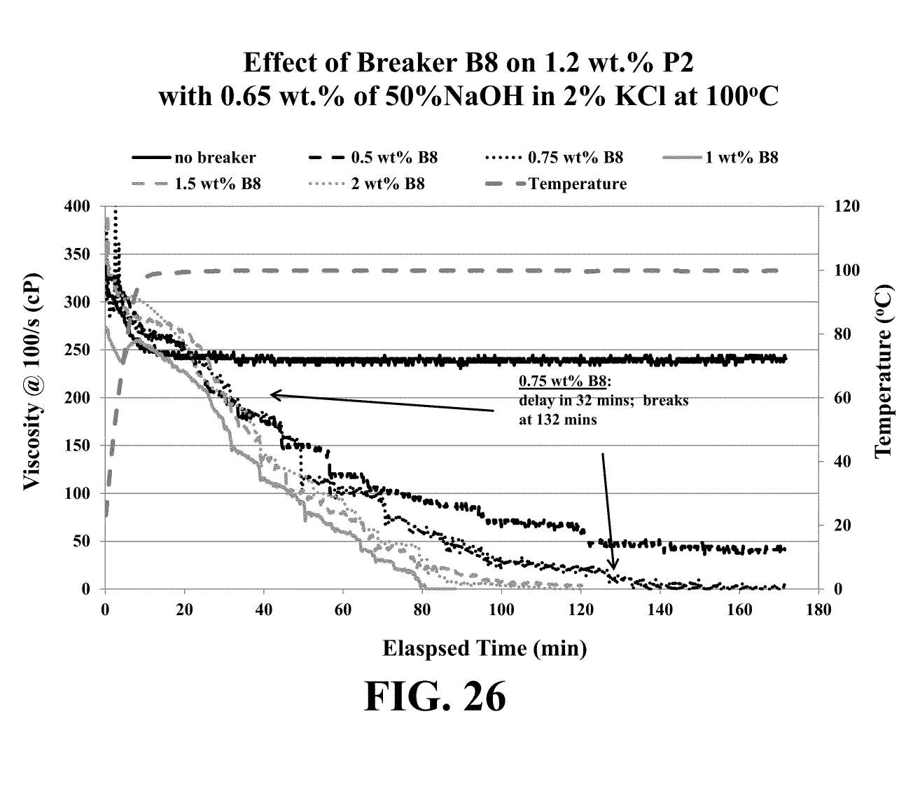

2 wt. % B8 broke the P2 system in about 88 minutes, which suggested that we can further lower the B8 concentration to prolong its breaking profile. As shown in FIG. 26, different concentrations of B8 were tested in the P2 system at 100° C.

The results showed that at B8 concentration of 0.75 wt. % or above, the P2 fluids may be broken at 100° C. At 0.75 wt. % B8, the P2 fluid viscosity was kept higher than 200 cP for about 32 minutes, and was completely broken at 132 minutes.

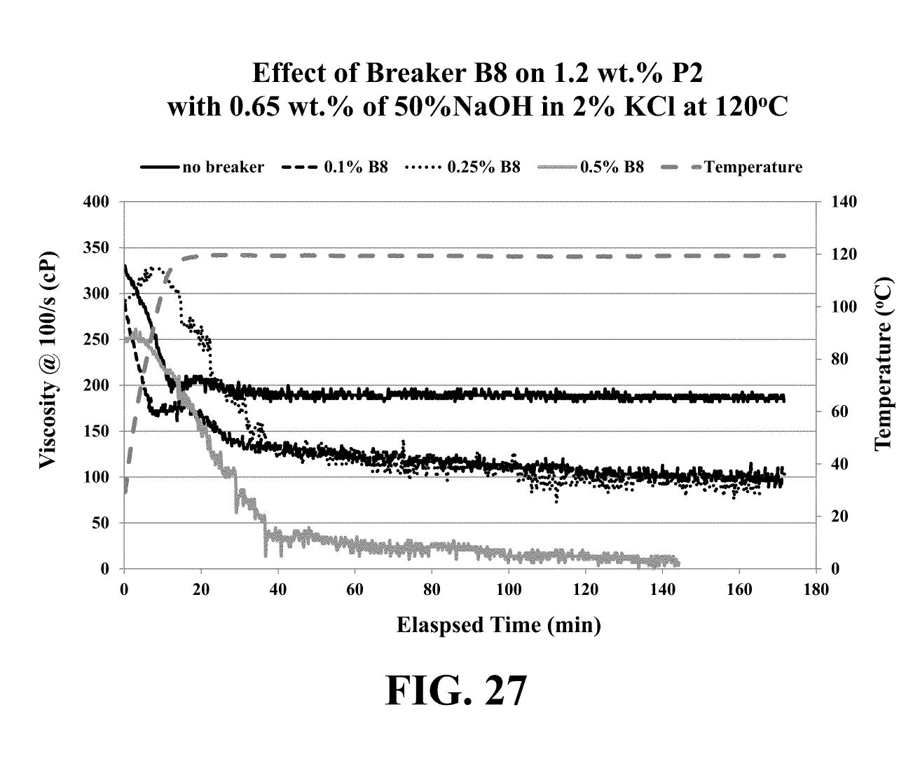

As shown in FIG. 27, the breaking profiles with varying concentrations of B8 at 120° C. from 0.1 wt. % to 0.5 wt. %, similar encapsulation strength may be seen once temperature started going up to 120° C. With 0.5 wt. % B8, the P2 fluid was broken down to 10 cP in 130 minutes; while lowering the concentration of B8 at 120° C. to 0.1 wt. % and 0.25 wt. %, no fluid breaking was observed. These results suggest that the outer cured resin does not adequately degrade at temperatures lower than 120° C.; and encapsulated material ammonium persulfate at 0.5 wt. % is sufficient to break the P2 fluid.

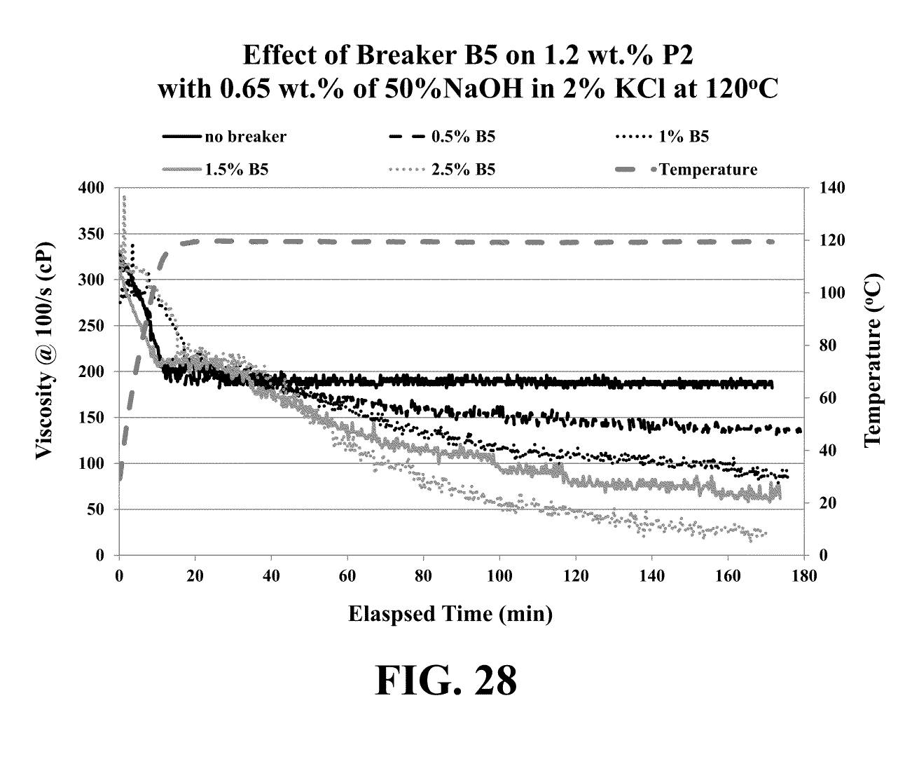

As shown in FIG. 28, the breaking profiles with varying concentrations of B5 from 0.5 wt. % to 2.5 wt. % at 120° C. was similar to the breaking profile of B8, which has a similar encapsulation strength, was observed in which B5 can hold a viscosity of 200 cP or above for about 20-40 minutes at 120° C. However, with 2.5 wt. % B5 did not completely break down to 10 cP, but was lowered to 24 cP in 3 hours.

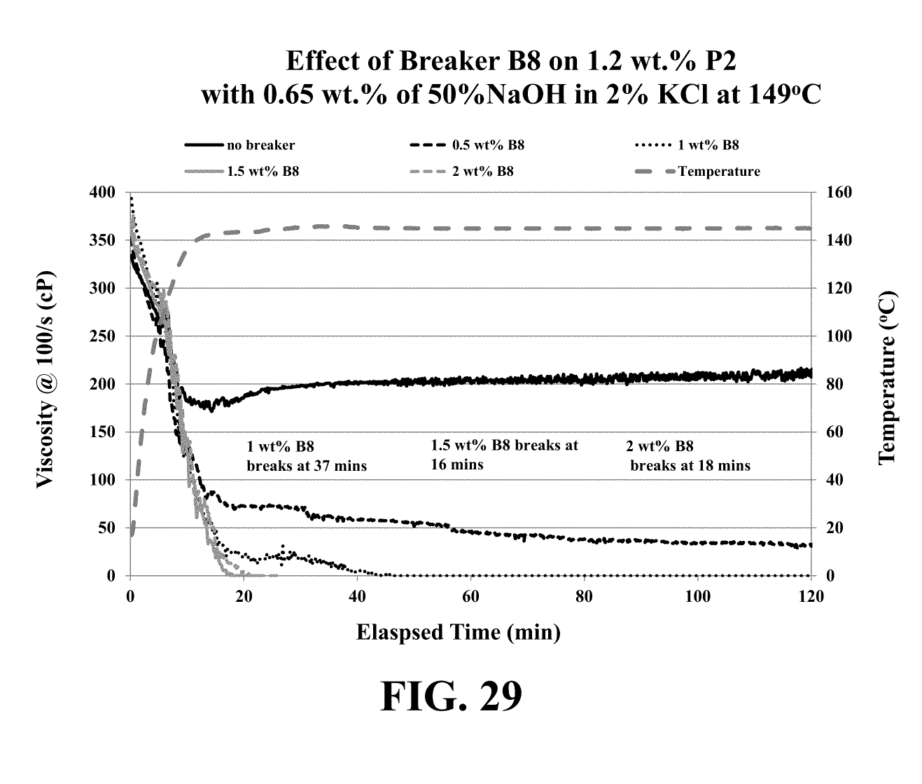

As shown in FIG. 29, the effect of B8 on fluid viscosity at 149° C. over 2 hours with varying concentrations of B8 from 0.5 wt. % to 2 wt. % at 149° C. was observed to hold a viscosity of 200 cP or above for less than 10 minutes at 149° C. Even with the 0.5 wt. % concentration, suspension viscosity dropped too soon. This suggests that lowering B8 concentration is possible.

In summary, breaking profiles were observed under 300 psi at different temperatures on Brookfield PVS. Further lowering breaker concentrations are possible, and improvement of the fluid system may be advanced. Table III, Table IV, Table V, Table VI, and Table VII show the summary of fluids when applying breakers at 40° C., 65° C., 80° C., 100° C., 120° C., and 149° C., respectively.

TABLE III
Fluid Breaking Summary at 65° C. on Brookfield PVS

| | | | Time delay to keep | | |
|---|---|---|---|---|---|
| | | TT | viscosity >200 | Viscosity (cP) | |
| | Breaker | (° C.) | cP (min) | after 3 hours | Comment |
| K940-2 | — | 65 | — | 341 | — |
| 3 hours | 2% B7 | 65 | 60 | 176 min broken | BROKEN |
| | | | | <10 cP | |

TABLE IV
Fluid Breaking Summary at 80° C. on Brookfield PVS

| | | TT | Time delay to keep | Viscosity (cP) | |
|---|---|---|---|---|---|
| | Breaker | (° C.) | viscosity >200 cP (min) | after 3 hours | Comment |
| K940-2 | — | 80 | — | 278 | — |
| 3 hours | 1.5% B3 | 80 | 40 | 133 mins broken <10 cP | BROKEN |
| | 2.0% B3 | 80 | 29 | 74 mins broken <10 cP | BROKEN |

TABLE V
Fluid Breaking Summary at 100° C. on Brookfield PVS

| | | TT | Time delay to keep | Viscosity (cP) | |
|---|---|---|---|---|---|
| | Breaker | (° C.) | viscosity >200 cP (min) | after 3 hours | Comment |
| K940-2 | — | 100 | — | 240 | — |
| 3 hours | 0.75% B8 | 100 | 32 | 132 min broken <10 cP | BROKEN |
| | 1.0% B8 | 100 | 27 | 81 min broken <10 cP | BROKEN |
| | 1.5% B8 | 100 | 30 | 98 min broken <10 cP | BROKEN |
| | 2.0% B8 | 100 | 31 | 88 min broken <10 cP | BROKEN |

TABLE VI
Fluid Breaking Summary at 120° C. on Brookfield PVS

| | | TT | Time delay to keep | Viscosity (cP) | |
|---|---|---|---|---|---|
| | Breaker | (° C.) | viscosity >200 cP (min) | after 3 hours | Comment |
| K940-2 | — | 120 | — | 233 | — |
| 3 hours | 0.5% B8 | 120 | 14 | ~130 min broken <10 cP | BROKEN |
| | 1.0% B6 | 120 | 10 | ~115 min broken <10 cP | BROKEN |
| | 0.5% B5 | 120 | 21 | 134 | Not broken |
| | 1.0% B5 | 120 | 39 | 82 | Not broken |
| | 1.5% B5 | 120 | 19 | 62 | Not broken |
| | 2.5% B5 | 120 | 39 | 24 | Not broken |

TABLE VII
Fluid Breaking Summary at 149° C. on Brookfield PVS

| | | | Time delay | Viscosity | |
|---|---|---|---|---|---|
| | | | to keep | (cP) | |
| | | TT | viscosity | after 2 | |
| | Breaker | (° C.) | >200 cP (min) | hours | Comment |
| K940-2 | — | 149 | — | 210 | — |
| | 2.0% B3 | 149 | 5 | 12 min | BROKEN |
| | | | | broken <10 cP | |
| | 2.0% B8 | 149 | 8 | 18 min | BROKEN |
| | | | | broken <10 cP | |
| | 2.0% B6 | 149 | 7 | ~2 hrs | BROKEN |
| | | | | broken <10 cP | |
| | 1.0% B8 | 149 | 7 | 40 min | BROKEN |
| | | | | broken <10 cP | |
| | 1.5% B8 | 149 | 8 | 17 min | BROKEN |
| | | | | broken <10 cP | |
| | 2.0% B8 | 149 | 8 | 18 min | BROKEN |
| | | | | broken <10 cP | |

### Additives Compatibility

Before applying this synthetic polymer gel system to field operation, commonly used fracturing additives were verified to see if they are compatible with the fluids. Commonly used fracturing additives are acids, biocide, breaker, clay stabilizer, crosslinker, fluid loss control, foamer, iron control, pH adjuster, non-emulsifier, proppants, solvent, etc. Exceptions are strong mineral acids and organic acids such as acetic acid, formic acid, and hydrochloric acid.

Additives that we have tested on this synthetic polymer include WNE-363, BioClear 2000, WGS-160L, and WCS-631LC. Formulation of fluid contains 1.2 wt. % P2 with 0.65 vol % of 50% NaOH in 2% KCl brine. Fluid was tested individually with additive at 100° C. to demonstrate the stability of fluid. Table VIII shows additives and their concentrations for testing.

TABLE VIII
Additives and Their Concentrations for Running the Compatibility Test

| ADDITIVES | FUNCTION | CONCENTRATION (gpt) |
|---|---|---|
| WNE-363 | Surfactant | 2 |
| BioClear 2000 | Biocide | 0.05 |
| WGS-160L | Gel Stabilizer | 3 |
| WCS-631LC | Clay Control Additive | 2 |

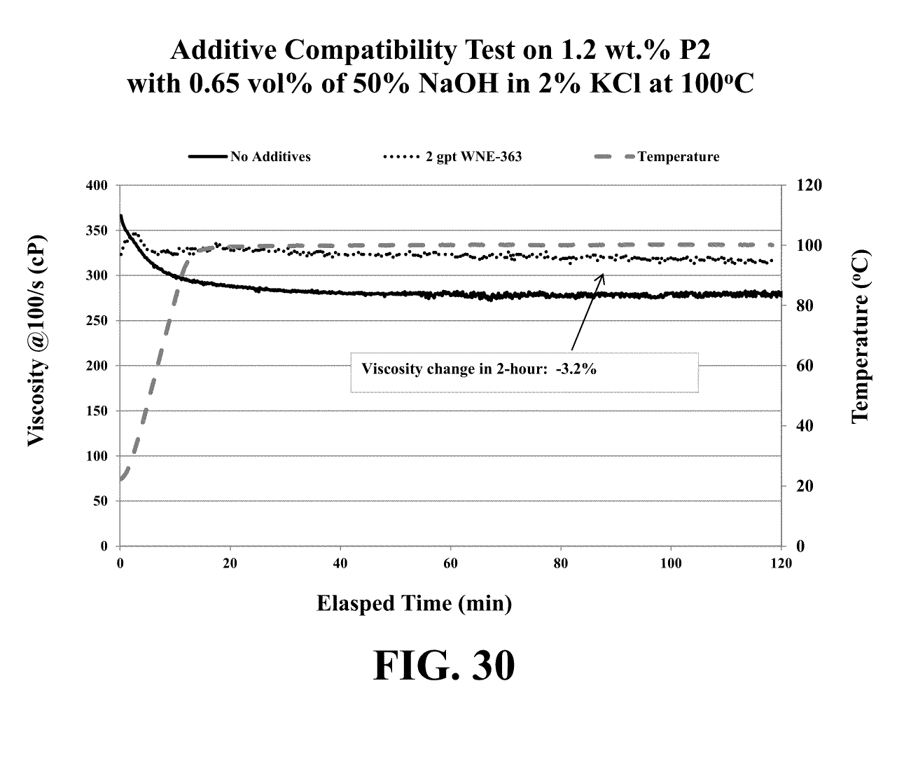

With 2 gpt WNE-363, the P2 fluid stayed stable in viscosity over 2 hours, minor viscosity dropped 3.2% as shown in FIG. 30. Note that viscosity change was calculated as the viscosities difference between the initial and final after fluid reached 100° C.

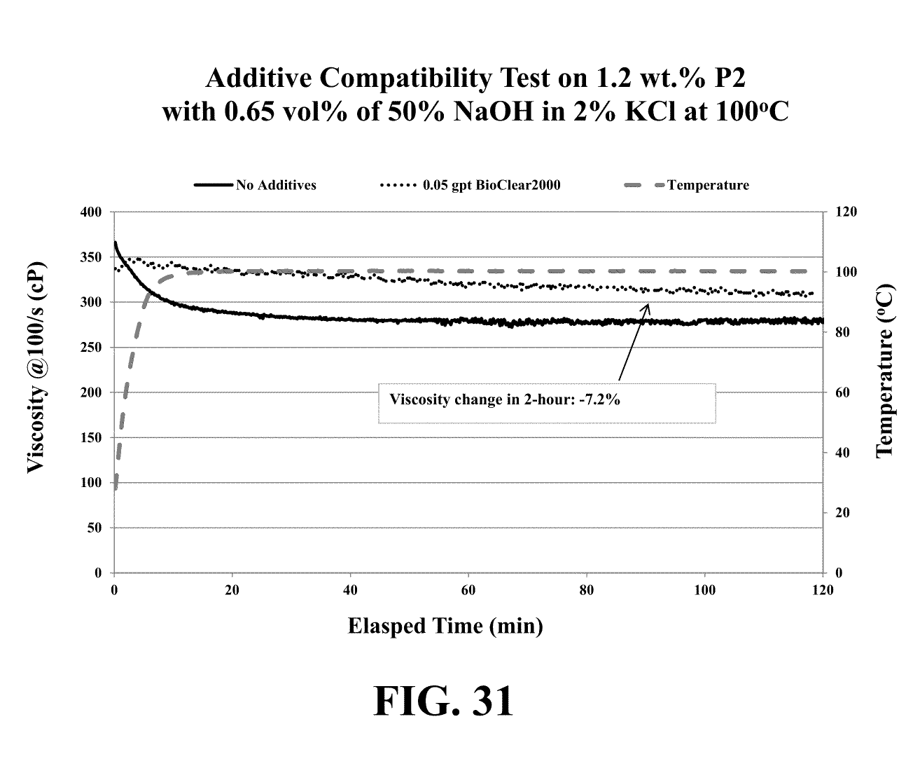

With 0.05 gpt BioClear 2000, the P2 fluid showed a minor viscosity dropped of 7.2% over 2 hours at 100° C. as shown in FIG. 31.

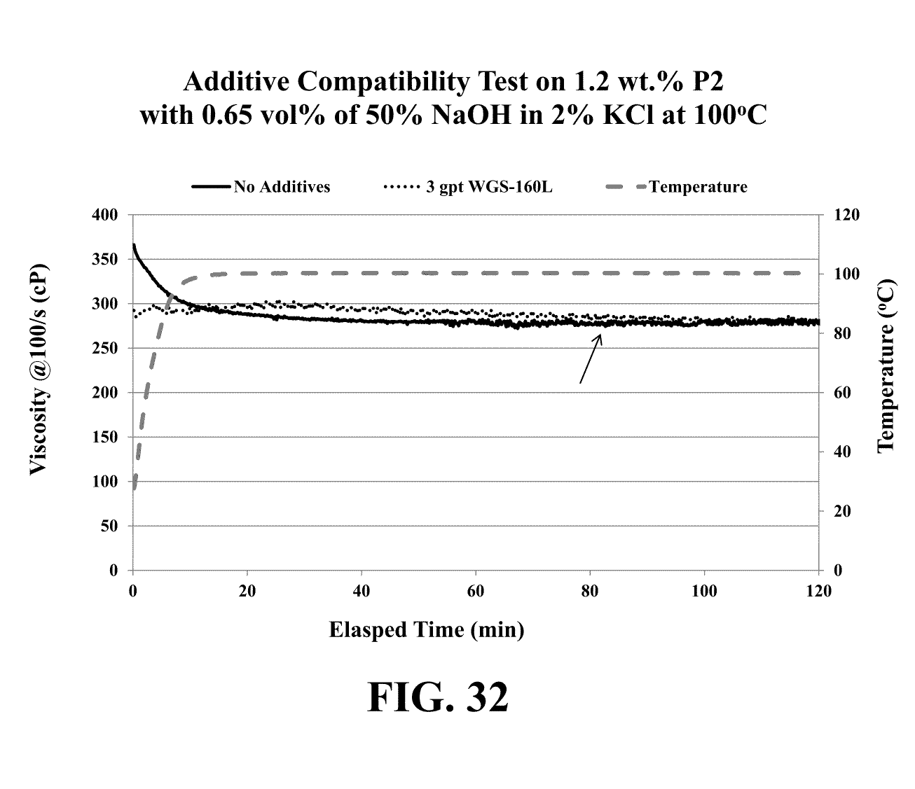

With 3 gpt WGS-160L, the P2 fluid stayed stable in viscosity over 2 hours, a minor viscosity dropped of 4.6% was observed as shown in FIG. 32.

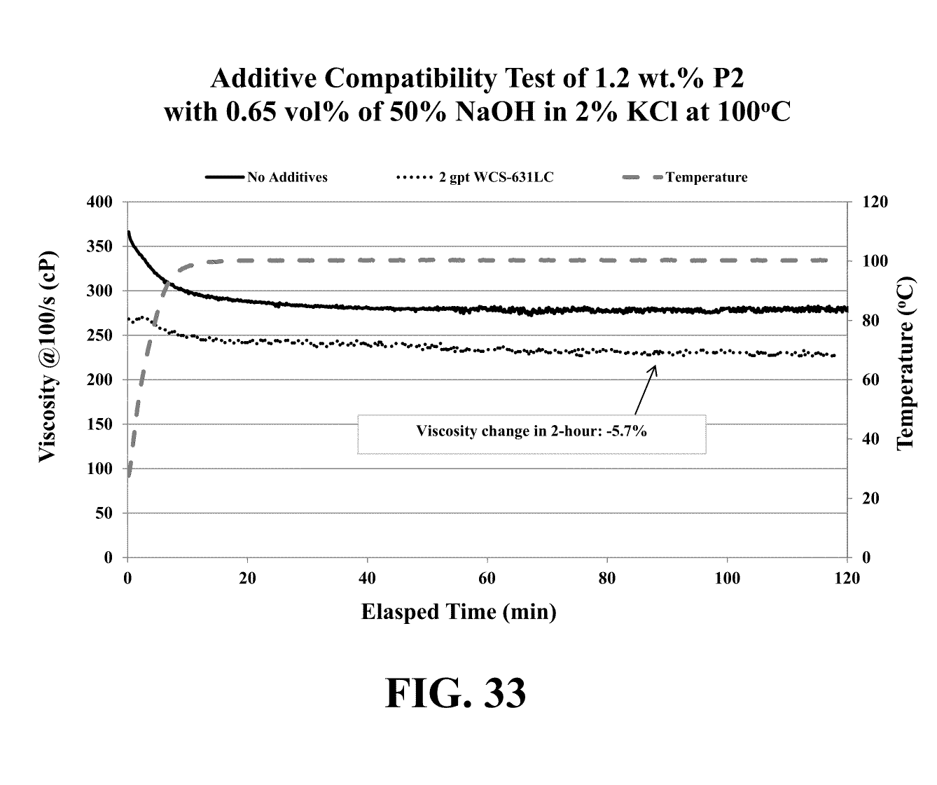

With 2 gpt WCS-631LC, the P2 fluid stayed stable in viscosity over 2 hours, a minor viscosity dropped of 5.7% was observed as shown in FIG. 33

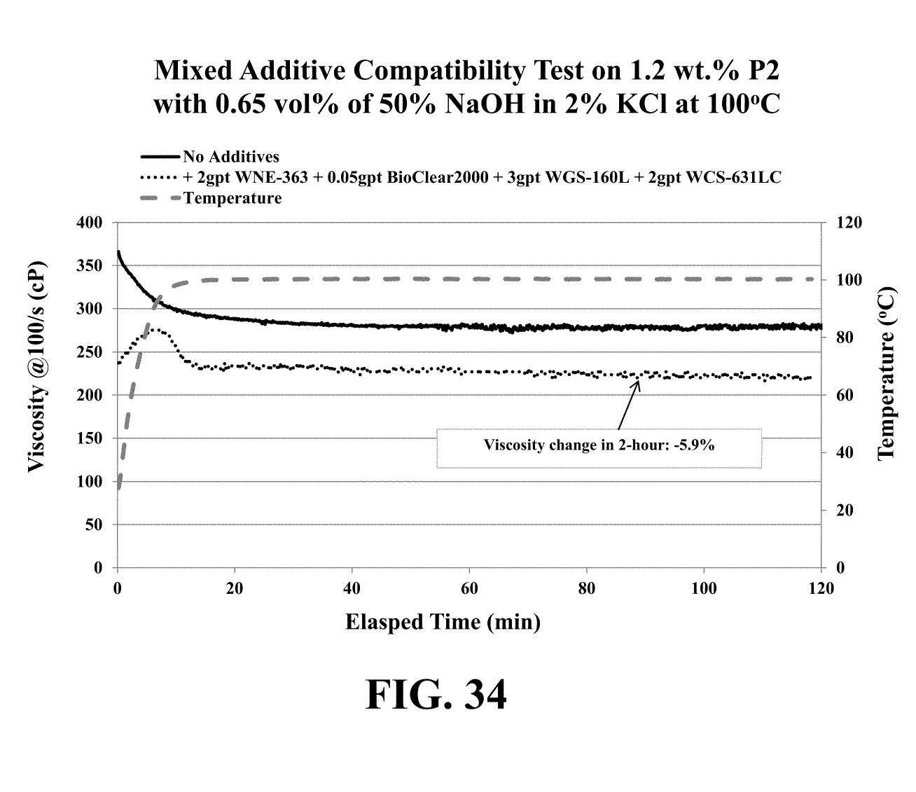

With a combination of 2 gpt WNE-363, 0.05 gpt BioClear 2000, 3 gpt WGS-160L, and 2 gpt WCS-631LC at 100° C., the P2 fluid stayed stable in viscosity over 2 hours, a minor viscosity dropped of 5.9% was observed as shown in FIG. 34. Therefore, results showed that with these commonly used fracturing additives at their typical concentrations, viscosity of fluids stay stable at least for 2 hours.

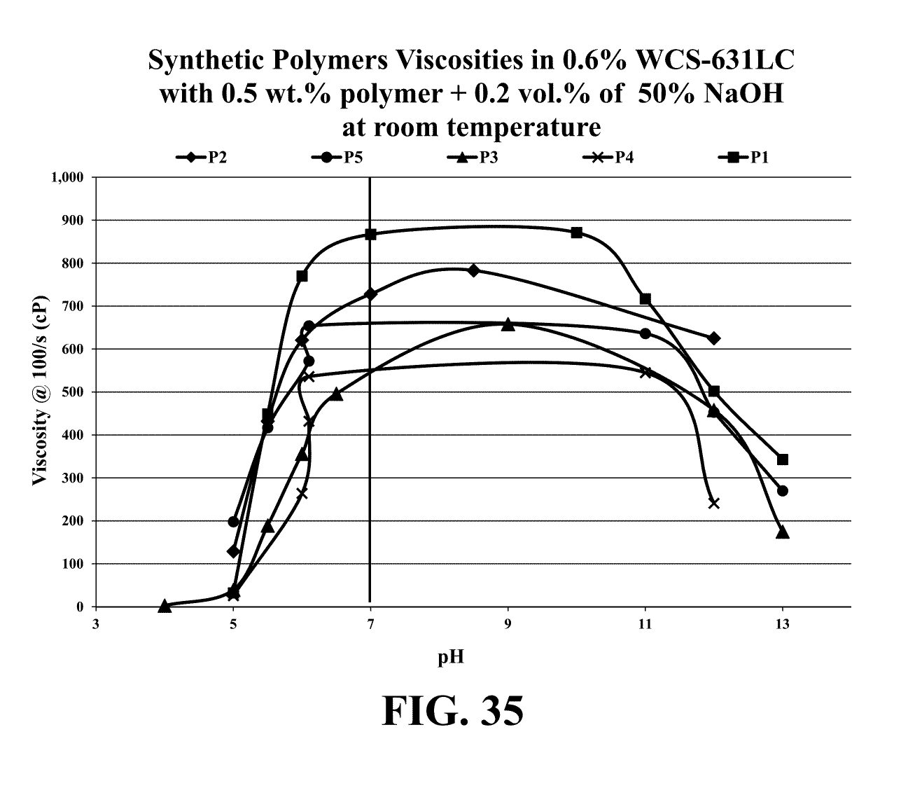

Referring to FIG. 35, synthetic polymer viscosities vs. pH profiles at room temperatures are shown for 0.5 wt. % P1-P5 fluid with 0.6 wt. % WCS-631LC added.

### Proppant Carrying Capability Comparison

In order to assess the sand carrying capabilities we loaded different viscosity synthetic gels and compared them to a conventional crosslinked borate system that is commonly used. The systems were placed in a waterbath at 80° C. and removed after 30 minutes and 2 hours to assess how much sand had settled.

Guar (0.625%) with KCl (2%), WPB-584L (0.05%), and BXL-10 (0.075%): Brookfield viscosity is 400 cP at 100/s at 80° C. The sand settled at the bottom of the jar within 30 minutes at the 80° C. water-bath.

P1 (0.30%) with CC120 (0.60%), and HMI (0.30%): Ofite 900 viscosity is 134 cP at 100 /s at room temperature. Play sand slightly settled at the lower part of the jar in 2 hours at the 80° C. water-bath.

P1 (0.30%) with CC120 (0.60%), and HMI (0.35%): Ofite 900 viscosity is 209 cP at 100 /s at room temperature. Play sand did not settle in the jar within 2 hours at the 80° C. water-bath.

P1 (0.30%) with CC120 (0.60%), and HMI (0.40%): Ofite 900 viscosity is 252 cP at 100 /s at room temperature. Play sand did not settle in the jar within 2 hours at the 80° C. water-bath.

P1 (0.30%) with CC120 (0.60%), and HMI (0.45%): Ofite 900 viscosity is 325 cP at 100 /s at room temperature. Play sand did not settle in the jar within 2 hours at the 80° C. water-bath.

The results clearly show the superior suspension capabilities of the synthetic polymer system even when using a lower viscosity over the conventional Dynafrac system. The use of lower viscosity fluids could enable lower pump pressures due to the reduction in friction pressure as the fluid is pumped down hole.

Another synthetic polymer P2, was also used for formulating the fluid in 2% KCl system. Proppant suspension capability of its fluid was compared with our conventional Dynafrac and xanthan gum systems. CARBO Ceramics's CARBO-HSP 20/40 with a specific gravity of 3.56 was used for this suspension test for comparison.

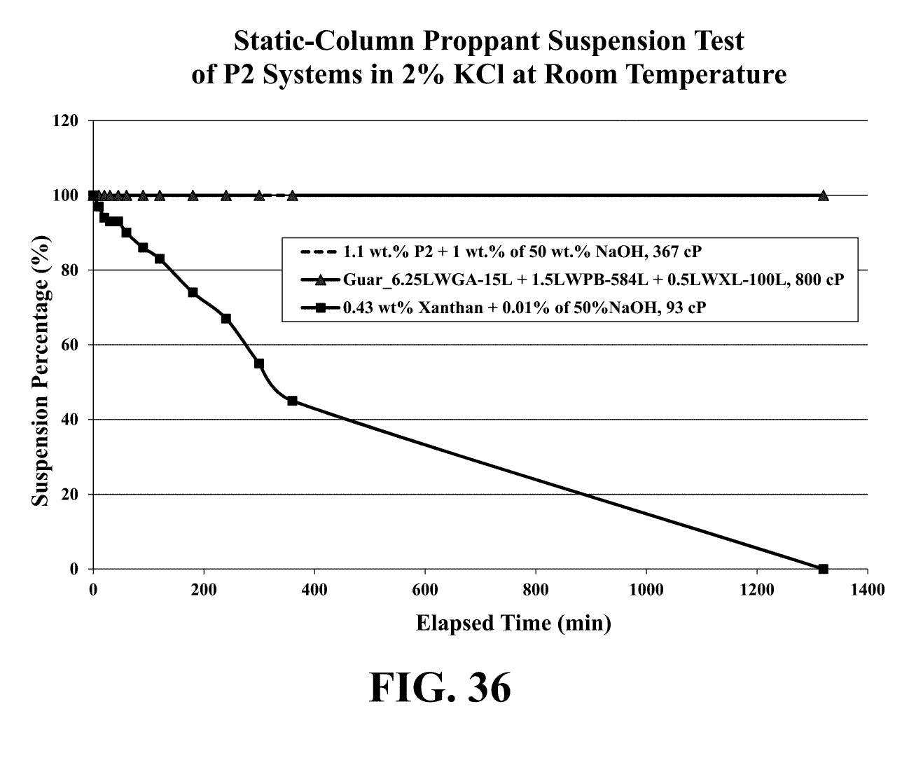

Results are showing below in FIGS. 36&37 at room temperature and 80° C. respectively.

At room temperature, 20° C.-25° C., both P2 and conventional Dynafrac natural polymers could suspend proppants over 22 hours. While with xanthan drops half of its suspension viscosity in 5 hours.

With the same formulation, while temperature rose to 80° C., the conventional Dynafrac gel started to drop half of its suspension viscosity in 4 hours; and fluid with xanthan drops half of its suspension viscosity in 30 minutes at 80° C. On the other hand, the fluid with synthetic polymer P2 suspension viscosity stays over 22 hours at 80° C.

Proppant suspension capabilities were tested for fluids including 1 wt. % P2 and 0.65 vol % of 50% NaOH having different viscosities at 100 /sec on OFITE 900 at room temperature and 80° C. respectively. The tested viscosities of the fluids were: 51.7 cP, 121.4 cP, 205 cP, and 262 cP. Most proppants dropped to the bottom at 51.7 cP within 10 minutes at 80° C. Most proppants dropped to the bottom at 121.4 cP in less than 3 hours at 80° C. Proppants appeared sticking on the glass wall while many of them had dropped down to the bottom. Proppants were suspended at the beginning and showed only a minor drop of proppants from the top at 205 cP after 24 hours at 80° C. Proppants suspension of 262 cP fluid at 80° C. at the beginning and after 24 hours, respectively showed no proppant dropping.

### CONCLUSIONS

Various formulations of the synthetic polymers were tested in three different systems: 0.2%-0.6% CC120, 2% KCl, and seawater. A minimum of 0.25 wt. % of P1 was used, with CC120 and HMI, to achieve a neutral pH fluid with the highest viscosity, i.e., 380 cP at room temperature from the OFITE Model 900. A minimum of 1.2 wt. % of P2 was used, with 2% KCl and 50% NaOH, to achieve a neutral pH fluid with the highest viscosity, i.e., 380 cP at room temperature from the OFITE Model 900. A minimum of 2.5 wt. % of P2 was used, with seawater and 50%-sodium hydroxide, to achieve a neutral pH fluid with the highest viscosity, i.e., 630 cP at room temperature from the OFITE Model 900. The minimum recommended hydration time is 3 minutes for the dry polymer to reach 90% of the highest viscosity for CC120 and 2% KCl systems at room temperature; and 5 minutes for the seawater system. The system is extremely sensitive to inorganic salts and further work is required to see if there is any way to improve this or look at other polymers from this family. The systems showed excellent fluid stability over a broad temperature range.

Additives for breakers have been found but further work is required to look in to different encapsulating additives with lower dosages over a broad range of temperature.

The system showed excellent compatibility with commonly used fracturing additives. The systems showed superior suspension capabilities over the standard borate system with lower polymer concentrations and viscosity.

All references cited herein are incorporated by reference. Although the invention has been disclosed with reference to its preferred embodiments, from reading this description those of skill in the art may appreciate changes and modification that may be made which do not depart from the scope and spirit of the invention as described above and claimed hereafter.

We claim:

1. A synthetic polymer composition comprising:
a major amount of synthetic hydratable polymers, and
a minor amount of natural hydratable polymers,
where the synthetic hydratable polymers are selected from the group consisting of (a) high molecular weight homo- and/or copolymers of acrylic acid crosslinked with polyalkenyl polyethers, (b) high molecular weight hydrophobically modified, cross-linked polyacrylate polymers, (c) hydrophilic, anionic, high molecular weight, cross-linked polyacrylic acid polymers, and (d) mixtures or combinations thereof,
where the natural hydratable polymers are selected from the group consisting of polysaccharides, polyacrylamides, polyacrylamide copolymers, and mixtures or combinations thereof,
where the polymer composition builds viscosity after being combined with an aqueous base fluid,
where the polymer composition breaks using one breaker or a plurality of breakers,
where the major amount is between 80 wt. % up to 100 wt. % and
where the minor amount is between 0 wt. % and 20 wt. %.

2. The composition of claim 1, wherein the major amount is between 95 wt. % and 100 wt. % of synthetic hydratable polymers and the minor amount is between 0 wt. % and 5 wt. %.

3. The composition of claim 1, wherein the major amount is between 99 wt. % and 100 wt. % of synthetic hydratable polymers and the minor amount is between 0 wt. % and 1 wt. %.

4. The composition of claim 1, wherein the composition is substantially free of natural hydratable polymers or include substantially no natural hydratable polymers.

5. A fracturing fluid composition comprising:
a base fluid and
an effective amount of a synthetic polymer composition including
a major amount of synthetic hydratable polymers and
a minor amount of a natural hydratable polymers,
where the synthetic hydratable polymers are selected from the group consisting of (a) high molecular weight homo- and/or copolymers of acrylic acid crosslinked with polyalkenyl polyethers, (b) high molecular weight hydrophobically modified, cross-linked polyacrylate polymers, (c) hydrophilic, anionic, high molecular weight, cross-linked polyacrylic acid polymers, and (d) mixtures or combinations thereof,
where the natural hydratable polymest are selected from the group consisting of polysaccharides, polyacrylamides, polyacrylamide copolymers, and mixtures or combinations thereof,
where the polymer composition builds viscosity after being combined with an aqueous base fluid,
where the polymer composition breaks using one breaker or a plurality of breakers,
where the major amount is between 80 wt. % up to 100 wt. %,
where the minor amount is between 0 wt. % and 20 wt. %, and
where the effective amount of the synthetic polymer composition is between 0.1 wt. % and about 10 wt. % of the entire fracturing fluid.

6. The composition of claim 5, further comprising:
proppants.

7. The composition of claim 5, further comprising:
modifying additives to modify the behavior of the fracturing fluids.

8. The composition of claim 5, further including:
a breaker composition capable of breaking the fracturing fluid in a controlled manner, where the breaker composition includes a salt solution or breaker compositions including an encapsulated salt.

9. The composition of claim 5, further comprising:
a crosslinking system to build viscosity.

10. The composition of claim 5, wherein the effective amount of the synthetic polymer composition is between 0.1 wt. % and about 5 wt. % of the entire fracturing fluid.

11. The composition of claim 5, wherein the effective amount of the synthetic polymer composition is between 0.1 wt. % and about 2.5 wt. % of the entire fracturing fluid.

12. The composition of claim 5, wherein the major amount is between 95 wt. % and 100 wt. % of synthetic hydratable polymers and the minor amount is between 0 wt. % and 5 wt. %.

13. The composition of claim 5, wherein the major amount between 99 wt. % and 100 wt. % of synthetic hydratable polymers and the minor amount is between 0 wt. % and 1 wt. %.

14. The composition of claim 5, wherein the composition is substantially free of natural hydratable polymers or include substantially no natural hydratable polymers.

15. A method for fracturing a formation or formation zone using fracturing fluids comprising:
injecting a fracturing fluid into a formation under fracturing conditions,
where the fracturing fluid includes:
a base fluid and
an effective amount of a synthetic polymer composition including
a major amount of synthetic hydratable polymers and
a minor amount of a natural hydratable polymers,
where the synthetic hydratable polymers are selected from the group consisting of (a) high molecular weight homo- and/or copolymers of acrylic acid crosslinked with polyalkenyl polyethers, (b) high molecular weight hydrophobically modified, cross-linked polyacrylate polymers, (c) hydrophilic, anionic, high molecular weight, cross-linked polyacrylic acid polymers, and (d) mixtures or combinations thereof,
where the natural hydratable polymest are selected from the group consisting of polysaccharides, polyacrylamides, polyacrylamide copolymers, and mixtures or combinations thereof,
where the polymer composition builds viscosity after being combined with the base fluid and breaks using one breaker or a plurality of breakers,
where the major amount is between 80 wt. % up to 100 wt. %,
where the minor amount is between 0 wt. % and 20 wt. %,
where the effective amount of the synthetic polymer composition is between 0.1 wt. % and about 10 wt. % of the entire fracturing fluid, and
where the fracturing fluid has a desired viscosity profile and a desired breaker profile.

16. The method of claim 15, further comprising:
injecting a proppant fluid including proppants into the formation under propping conditions.

17. The method of claim 15, wherein the fracturing fluid further includes:
proppants.

18. The method of claim 15, wherein the fracturing fluid further includes:
modifying additives to modify the behavior of the fracturing fluids.

19. The method of claim 15, wherein the fracturing fluid further includes:
a breaker composition capable of breaking the fracturing fluid in a controlled manner.

20. The method of claim 15, wherein the fracturing fluid further includes:
a crosslinking system into the fracturing fluid to build viscosity.

21. The method of claim 15, wherein the effective amount of the synthetic polymer composition is between 0.5 wt. % and about 5 wt. % of the entire fracturing fluid.

22. The method of claim 15, wherein the effective amount of the synthetic polymer composition is between 1.0 wt. % and about 2.5 wt. % of the entire fracturing fluid.

23. The method of claim 15, wherein the major amount is between 95 wt. % and 100 wt. % of synthetic hydratable polymers and the minor amount is between 1 wt. % and 5 wt. %.

24. The method of claim 15, wherein the major amount is between 99 wt. % and 100 wt. % of synthetic hydratable polymers and the minor amount is between 0 wt. % and 1 wt. %.

25. The method of claim 15, wherein the composition is substantially free of natural hydratable polymers or include substantially no natural hydratable polymers.
